(19) United States
(12) Patent Application Publication
(10) Pub. No.: US 2025/0297192 A1
(43) Pub. Date: Sep. 25, 2025

(54) BIODEGRADABLE GRAFT POLYMERS USEFUL FOR DYE TRANSFER INHIBITION

(71) Applicant: BASF SE, Ludwigshafen Am Rhein (DE)

(72) Inventors: Jan Ole MUELLER, Ludwigshafen am Rhein (DE); Swati DE, Ludwigshafen am Rhein (DE); Marcel WALASCHEK, Ludwigshafen am Rhein (DE); Jessica NEUMANN, Ludwigshafen am Rhein (DE); Florian SCHOEN, Ludwigshafen am Rhein (DE)

(73) Assignee: BASF SE, Ludwigshafen Am Rhein (DE)

(21) Appl. No.: 18/995,500

(22) PCT Filed: Jul. 14, 2023
(86) PCT No.: PCT/EP2023/069689

§ 371 Date: Jan. 16, 2025

(30) Foreign Application Priority Data
Jul. 21, 2022 (EP) 22186190.9

(51) Int. Cl. C11D 3/37; C08F 283/06; C11D 3/00; C11D 3/20; C11D 3/24; C11D 3/48

(52) U.S. Cl. CPC C11D 3/3788; C08F 283/06; C11D 3/0021; C11D 3/2068; C11D 3/24; C11D 3/48

(57) ABSTRACT

This application relates to biodegradable graft polymers for use as e.g. dye transfer inhibitors especially in laundry applications. The graft polymers of the invention comprise a polyalkylene oxide polymer as polymer backbone of the graft polymer and grafted side chains obtained from radically polymerizing at least one vinylimidazole-monomer or derivative thereof, and at least one vinyl lactame and optionally further monomers in the presence of the polymer backbone. The inventive graft polymers exhibit among others dye transfer inhibition properties: as they also are bio-degradable. they are especially useful polymers for fabric and home care and cleaning applications to prevent dye transfer. The invention further relates to the production of such graft polymers. Furthermore, the present invention relates to the use of such a graft polymer within fabric and home care products and cleaning compositions, and the use of such graft polymers for inhibiting the dye transfer in laundry applications, and the compositions and products as such containing such a graft polymer.

This application relates to biodegradable graft polymers for use as dye transfer inhibitors especially in laundry applications.

The graft polymers of the invention comprise a polyalkylene oxide polymer as polymer backbone of the graft polymer and grafted side chains obtained from radically polymerizing at least one vinylimidazole-monomer or derivative thereof, and at least one vinyl lactame in the presence of the polymer backbone, wherein no vinyl ester monomer is being employed.

The inventive graft polymers exhibit dye transfer inhibition properties; as they also are bio-degradable, they are useful polymers for laundry cleaning applications to prevent dye transfer.

The invention further relates to the production of such graft polymers.

Furthermore, the present invention relates to the use of such a graft polymer within fabric care and home care products, and the use of such graft polymers for inhibiting the dye transfer in laundry applications.

This invention also relates to fabric and home care products as such containing such a graft polymer. Such graft polymers for use in dye transfer inhibition are not yet known.

Due to the climate change, one of the most important targets of the detergent and cleaning (D&C) industry today is to significantly lower the CO2 emission per wash, by improving e.g. cold water conditions by improving the cleaning efficiency at low temperatures of below 40, 30 or 20 or even colder, to lower the amounts of chemicals employed per wash, increasing the weight-efficiency of the cleaning technologies, reducing the amount of water per wash, introducing bio-derived components etc. Hence, one important target of the D&C industry is the need to improve the sustainability of the cleaning formulations by improving efficiency, especially also at lower temperatures, needing less water (especially also in the laundry and dish wash formulations) and to avoid the accumulation of non-degradable compounds in the ecosystem. Such reduction in CO2-emision or the desire to improve the “footprint” of any product is of high and even further rising interest in the industry and with the consumers, be it in terms of its origin like being from natural or renewable resources, or—all compared to previous products-its production in terms of production efficiency and thus reduced usage of energy, its efficiency in usage such as reduced amounts for the same performance or higher performance at the same amount levels used, its persistence in the natural environment upon and/or after its usage such as bio-degradation.

As a result of these trends, there is a strong need for new biodegradable cleaning additives that provide at least comparable cleaning properties and a reduction in the CO2-footprint by being bio-derived, bio-degradable or even both. The materials should preferably exhibit good primary cleaning activity, soil removal for oily/fatty and particulate stains and/or should lead to improved whiteness maintenance, thus minimizing also the amount of suspended and emulsified oily/fatty and particulate soil from redepositing on the surfaces of the textiles or hard surfaces, etc.

Hence, one need resides in the provision of compounds being bio-degradable and still having at least the same performance as already known but not bio-degradable compounds, such biodegradation as measured under de-fined conditions within 28 days as to be required by many users especially in the field of detergents, and as being a future requirement by applicable legislation in several countries and regions of the world.

When laundering fabrics, dye transfer can cause challenges such as that dyes from one portion of a fabric may become suspended in a wash liquor and may then deposit on a different portion of the fabric, or on a different fabric altogether. Transfer of such dyes (known as “fugitive dyes”) can cause dye graying and discoloration of fabrics, especially of those of a light or white color. Certain polymers, generally known as dye transfer inhibitor/inhibition polymers (“DTI”-polymers; “DTI” also used for “dye transfer inhibition”), have traditionally been used in laundry compositions to address the dye transfer problem. Such polymers include poly-1-vinylpyrrolidone (PVP), poly(vinylpyridine-N-oxide) (PVNO), poly-1-vinylpyrrolidone-co-1-vinylimidazole (PVPVI), and polyvinylpyrrolidone (vinylpyridine-N-oxide (PVPVNO) polymers, which have typically included relatively high levels of 1-vinyl pyrrolidone (“VP”). These traditional DTI polymers are quite effective at inhibiting the transfer of direct dyes, but are not biodegradable due to their carbon-carbon-backbone, which cannot be attacked successfully by microbes.

Copolymers of 1-vinylimidazole and 1-vinylpyrrolidone and their use as efficient dye transfer inhibitor (DTI) in laundry application (liquid, gel-like and solid colour care detergents) are well known (such as “Sokalan® HP 56” by BASF) and are regarded as “gold-standard”. Those polymers show an excellent dye transfer inhibition at very low amounts, but are—as well as all the before mentioned other known DTI-polymers—not biodegradable in any significant amount as they also have a carbon-carbon-bonded polymer backbone chain.

However, biodegradation of such polymers for use in detergent applications is highly desirable, as a certain amount of consumer products containing such polymers is rinsed away after their use and may, if not biodegraded or otherwise removed in the sewage treatment plant, end up in the river or sea. It is therefore highly desirable to identify better biodegradable ingredients for such applications. This problem of poor biodegradability is predominantly serious for polymers produced by radical polymerization based on carbon-only backbones (i.e., a backbone not containing heteroatoms such as oxygen or nitrogen), since a carbon-only backbone is particularly difficult to degrade for microorganisms. Even radically produced graft polymers of industrial importance with a polyethylene glycol backbone show only limited biodegradation in waste-water.

Low molecular weight polyethylene oxide with Mw of 600 g/mol is known to be easily biodegradable, whereas polyethylene oxide with Mw of 6000 g/mol is only poorly biodegradable. BASF's safety data sheet for Pluriol® E 600, revised version 2.0, dated 05. January 2021, affirms for polyethylene glycol with Mw=600 g/mol a DOC value (dissolved organic carbon) measured according to OECD 301A of >70%. In contrast to that, the biodegradability of polyethylene glycol with Mw=6000 g/mol is mentioned in BASF's safety data sheet for Pluriol® E 6000 Pellet, revised version 2.0, dated 10. August 2018, to be only poor, showing only 10-20% CO₂ formation relative to the theoretical value (60 d) according to OECD 301B.

Various further attempts have already been made to provide DTI-polymers of similar performance as the copolymers 1-vinylimidazole and 1-vinylpyrrolidone, but none has achieved a similar performance in DTI or/neither a useful bio-degradability.

WO 03/042262 relates to “graft polymers” comprising (A) a polymer graft skeleton with no mono-ethylenic unsaturated units and (B) polymer sidechains formed from co-polymers of two different mono-ethylenic unsaturated monomers (B1) and (B2), each comprising a nitrogen-containing heterocycle, whereby the proportion of the sidechains (B) amounts to 35 to 55 wt. % of the total polymer.

However, the graft polymers according to WO 03/042262 do employ larger amounts of vinyl imidazole and vinylpyrrolidone-monomers for the production of the respective polymer sidechains grafted onto the backbone. The performance of those polymers in DTI is acceptable but still far from the gold-standard. Bio-degradation is not mentioned. In view of the higher amounts of vinyl monomers, also the production cost is higher.

U.S. Pat. No. 5,318,719 relates to a class of biodegradable water-soluble graft copolymers having building, anti-filming, dispersing and threshold crystal inhibiting properties comprising (a) an acid functional monomer and optionally (b) other water-soluble, monoethylenically unsaturated monomers copolymerizable with (a) grafted to a biodegradable substrate comprising polyalkylene oxides and/or polyalkoxylated materials. However, U.S. Pat. No. 5,318,719 does employ for the production of the side chains of said graft polymers mandatorily a high amount of acid-functional monomers such as acrylic acid or methacrylic acid. Such type of acid monomers are not useful within the context of the present invention, as they would disturb the DTI-action of the amine-(imidazole) groups and lactam groups.

US 2019/0390142 relates to fabric care compositions that include a graft copolymer, which may be composed of (a) a polyalkylene oxide, such as polyethylene oxide (PEG); (b) N-vinylpyrrolidone (VP); and (c) a vinyl ester, such as vinyl acetate. However, US 2019/0390142 does not disclose further Nitrogen-containing monomers such as vinylimidazole. Also, the amounts of backbone and monomers employed and the intended uses differ.

WO 2007/138053 discloses amphiphilic graft polymers based on water-soluble polyalkylene oxides (A) as a graft base and side chains formed by polymerization of a vinyl ester component (B), said polymers having an average of less than one graft site per 50 alkylene oxide units and mean molar masses M of from 3 000 to 100 000. However, WO 2007/138053 does not contain any disclosure in respect of the biodegradability of the respective graft polymers disclosed therein nor does it disclose any high amounts of nitrogen-containing monomers.

WO2021160795A1 relates to graft polymers comprising a block copolymer backbone (A) as a graft base having polymeric sidechains (B) grafted thereon. The polymeric sidechains (B) are obtainable by polymerization of at least one vinyl ester monomer (B1) and optionally N-vinylpyrrolidone as optional further monomer (B2). Most preferably, the block copolymer backbone (A) is a triblock copolymer of polyethylene oxide (PEG) and polypropylene oxide (PPG). The invention further relates to the use of such a graft polymer within, for example, fabric and home care products. However, besides the only as “optional” included monomer vinylpyrrolidone and the required vinyl ester monomer, no other monomers are to be included, specifically no vinylimidazole-monomer. The application as a DTI is also not mentioned.

WO2020/005476 discloses a fabric care composition comprising a graft copolymer and a so-called treatment adjunct, the graft copolymer comprising a polyalkylene oxide as backbone based on ethylene oxide, propylene oxide, or butylene oxide, preferably poly ethylene oxide, and N-vinylpyrrolidone and vinyl ester as grafted side chains on the backbone and with backbone and both monomers in a certain ratio. Vinylimidazole is not disclosed as a monomer. However, DTI is mentioned as target application of the inventive fabric care composition; the explicit use of the graft polymer as such as DTI-polymer is not explicitly disclosed besides a “belief” that if the molecular weight of the graft base, e.g. polyethylene glycol, is relatively low, there may be a performance decrease in dye transfer inhibition, but also that when the molecular weight is too high, the polymer may not remain suspended in solution and/or may deposit on treated fabrics. DTI-performance seems to be attributed to the specific combinations of compounds claimed but not the graft polymer as such alone, even more so, further “treatment adjuncts” mentioned as preferred ingredients are the known DTI-polymers as mentioned above as general state of the art known to a skilled person.

WO2020/264077 discloses cleaning compositions containing a combination of enzymes with a polymer such scomposition being suitable for removal of stains from soiled material. This publication discloses a so-called “suspension graft copolymer” which is selected from the group consisting of poly(vinylacetate)-g-poly (ethylene glycol), poly (vinylpyrrolidone)-poly (vinyl acetate)-g-poly (ethylene glycol), and combinations thereof, and thus does not include vinylimidazole as monomer. Moreover, specifically claimed is that besides that suspension graft polymer typical known dye transfer inhibitor-polymers (those mentioned above as general state of the art known to a skilled person) are comprised in the claimed fabric cleaning compositions.

WO0018375 discloses pharmaceutical compositions comprising a graft polymers obtained by polymerization of at least one vinyl ester of aliphatic C1-C24-carboxylic acids in the presence of polyethers, with the vinyl ester preferably being vinyl acetate. In the most preferred version the graft polymer is prepared from grafting vinyl acetate on PEG of Mw 6000 g/mol and thereafter hydrolyzing the vinyl acetate to the alcohol (which would then resemblea polymer being obtained from the hypothetical monomer “vinlyalcohol”). Main use is the formation of coatings and films on solid pharmaceutical dosage forms such as tablets etc.

Also claimed in WO0018375 however is a polymer being obtained by polymerization of at least one vinyl ester of aliphatic C1-C₆-carboxylic acids in the presence of polyethers with at least one monomer selected from the group of c1) C1-C6-alkyl esters of monoethylenically unsaturated C3-C8-carboxylic acids; c4) N-vinylpyrrolidone, N-vinylimidazole, N-vinylcaprolactam; c5) (meth)acrylic acid. Also claimed in WO0018375 is a polymer wherein, in addition to the vinyl esters, at least one other monomer c) selected from the group of c1) C1-C24-alkyl esters of monoethylenically unsaturated C3-C8-carboxylic acids; c2) C1-C24-hydroxyalkyl esters of monoethylenically unsaturated C3-C8-carboxylic acids; c3) C1-C24-alkyl vinyl ethers; c4) N-vinyllactams; c5) monoethylenically unsaturated C3-C8-carboxylic acids is used for the polymerization.

Further claimed in WO0018375 is also a polymer wherein, in addition to the vinyl esters, at least one other monomer c) selected from the group of c1) C1-C6-alkyl esters of monoethylenically unsaturated C3-C8-carboxylic acids; c4) N-vinylpyrrolidone, N-vinylimidazole, N-vinylcaprolactam; c5) (meth)acrylic acid is used for the polymerization.

As polymer backbones in WO0018375 polyethers having a number average molecular weight in the range below 500000, preferably in the range from 300 to 100000, particularly preferably in the range from 500 to 20000, very particularly preferably in the range from 800 to 15000 g/mol are disclosed. It is further mentioned a advantageous to use homopolymers of ethylene oxide or copolymers with an ethylene oxide content of from 40 to 99% by weight and thus a content of ethylene oxide units in the ethylene oxide polymers preferably being employed from 40 to 100 mol %. Suitable as comonomers for these copolymers are said to be propylene oxide, butylene oxide and/or isobutylene oxide, with suitable examples being said to be copolymers of ethylene oxide and propylene oxide, copolymers of ethylene oxide and butylene oxide, and copolymers of ethylene oxide, propylene oxide and at least one butylene oxide. The ethylene oxide content in the copolymers is stated to be preferably from 40 to 99 mol %, the propylene oxide content from 1 to 60 mol % and the butylene oxide content in the copolymers from 1 to 30 mol %. Not only straight-chain but also branched homo- or copolymers are said to be usale as grafting base for the grafting.

Exemplified however are in WO0018375 only PEG 6000 and 9000, a “polyethylene glycol/polypropylene glycol block copolymer” (with average molecular weight “about 8000”) and “polyglycerol” (with average molecular weight “2200”) (all in g/mol). Five examples only employ vinyl acetate, and only one example employs vinylacetate and methyl methacrylate as monomers. No other monomers are exemplified. All examples employ as final step the hydrolysis of the polymerized vinyl acetate monomer.

Hence, no polymer is being produced and characterized in WO0018375 containing no vinyl ester monomer but the further required monomers as claimed in the present invention.

Also not disclosed in WO0018375 is the use of such polymers as disclosed herein for detergent and cleaning or fabric care applications, and specifically not for use as DTI-polymers. No such application or uses are mentioned at all in this disclosure.

US2008/255326 discloses a process for preparing a graft polymer comprising a polyalkylene oxide polymer as a graft base, such as poly ethylene glycol, a vinyl ester such as vinyl acetate, and a vinyllactame such as vinyl pyrrolidone, both to be grafted onto the poly alkylene oxide-backbone, and optionally a monomer from a third category (“monomer c)”) in amounts of zero to up to 10 (ten) weight percent based on the total amount of the graft monomers, with the total amount of graft monomers adding up to 100 weight percent, and the amount of all graft monomers being 10 to 95 weight percent based on the total weight of the resulting graft polymer. Vinyl acetate nor any other vinyl ester-monomer however is being used by the present invention.

US 2019/390142 A1 does not disclose graft-polymers comprising vinyl imidazole as monomer, nor any other amine-containing monomer as required by the present invention. Also, the use of the graft polymers of this disclosure for inhibition of the transfer of dyes during washing is not disclosed. The only mentioned vinylimidazol-containing polymers being employed as dye transfer inhibitors within the disclosed compositions are the known copolymers of vinylimidazol and vinylpyrrolidone such as Sokalan HP 56, i.e. standard linear copolymers of those two monomers.

### DETAILED DESCRIPTION

As used herein, the articles “a” and “an” when used in a claim or an embodiment, are understood to mean one or more of what is claimed or described. As used herein, the terms “include(s)” and “including” are meant to be non-limiting, and thus encompass more than the specific item mentioned after those words.

The compositions of the present disclosure can “comprise” (i.e. contain other ingredients), “consist essentially of” (comprise mainly or almost only the mentioned ingredients and other ingredients in only very minor amounts, mainly only as impurities), or “consist of” (i.e. contain only the mentioned ingredients and in addition may contain only impurities not avoidable in an technical environment, preferably only the ingredients) the components of the present disclosure.

Similarly, the terms “substantially free of . . . ” or “substantially free from . . . ” or “(containing/comprising) essentially no . . . ” may be used herein; this means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or even less than 0.1%, or even more less than 0.01%, or even 0%, by weight of the composition.

The term “about” as used herein encompasses the exact number “X” mentioned as e.g. “about X %” etc., and small variations of X, including from minus 5 to plus 5% deviation from X (with X for this calculation set to 100%), preferably from minus 2 to plus 2%, more preferably from minus 1 to plus 1%, even more preferably from minus 0.5 to plus 0.5% and smaller variations. Of course if the value X given itself is already “100%” (such as for purity etc.) then the term “about” clearly can and thus does only mean deviations thereof which are smaller than “100”.

The phrase “fabric care composition” is meant to include compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein and detailed herein below when describing the compositions. Such compositions may be used as a pre-laundering treatment, a post-laundering treatment, or may be added during the rinse or wash cycle of the laundering operation, and as further detailed herein below when describing the use and application of the inventive graft polymers and compositions comprising such graft polymers.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (C) unless otherwise indicated. Unless otherwise specified, all measurements herein are conducted at 20° C. and under the atmospheric pressure. In all embodiments of the present disclosure, all percentages are by weight of the total composition, unless specifically stated otherwise. All ratios are weight ratios, unless specifically stated otherwise.

### Graft Polymer

The present invention encompasses a graft polymer comprising a polymer backbone as graft base as a first structural unit and polymeric side chains as a second structural unit:

The first structural unit of the graft polymer is a polymer backbone used as a graft base for the inventive graft polymer, wherein said polymer backbone (A) is obtainable by polymerization of at least one alkylene oxide monomer selected from the group of C2- to C10-alkylene oxides, preferably C2 to C5-alkylene oxides, such as ethylene oxide, 1,2 propylene oxide, 1,2 butylene oxide, 2,3 butylene oxide, 1,2-pentene oxide or 2,3 pentene oxide; from 1,4-diols or their cyclic or oligomeric analogs, or being based on polymeric ethers of such 1,4-diols; from 1,6-diols or their cyclic or oligomeric analogs, or being based on polymeric ethers of such 1,6-diols; or any of their mixtures in any ratio, either as blocks of certain polymeric units, or as statistical polymeric structures, or a polymers comprising one or more homo-block(s) of a certain monomer and one or more statistical block(s) comprising more than one such monomer, and any combination thereof such as polymers having several different blocks of 45 different monomers, or blocks of two different monomers, blocks of statistical mixtures of two or more monomers etc.

The term “block (co) polymer (backbone)” as used herein means that the respective polymer comprises at least two (i.e. two, three, four, five or more) homo- or co-polymer subunits (“blocks”) linked by covalent bonds. “Two-block” copolymers have two distinct blocks (homo- and/or co-polymer subunits), whereas “triblock” copolymers have, by consequence, three distinct blocks (homo- and/or co-polymer subunits) and so on. The number of individual blocks within such block copolymers is not limited; by consequence, a “n-block copolymer” comprises n distinct blocks (homo- and/or co-polymer subunits). Within the individual blocks the size/length of such a block may vary independently from the other blocks. The smallest length/size of a block is based on two individual monomers (as a minimum), but may be as large as 50. The respective monomers to be employed for preparing the individual blocks of a block copolymer backbone (A) may be added in sequence. However, it is also possible that there is a transition of the feed from one monomer to the other to produce so called “dirty structures” wherein at the edge/border of the respective block a small number of monomers of the respective neighboring block may be contained within the individual block to be considered (so called “dirty structures” or “dirty passages”). However, it is preferred that the block copolymer backbones (A) according to the present invention do not contain any dirty structures at the respective border of the blocks, although for commercial reasons (i.e. mainly cost for efficient use of reactors etc.) small amounts of dirty structures may still be contained although not deliberately being made.

Preferably at least one monomer in the polymer backbone stems from the use of ethylene oxide. In a preferred embodiment the backbone is made from ethylene oxide only.

In another embodiment, more than one alkylene oxide monomer is comprised in the structure of the polymer backbone; in such case the polymer backbone is a random copolymer, a block copolymer or a copolymer comprising mixed structures of block units (with each block being a homo-block or a random block itself) and statistical/random parts comprised of two or more alkylene oxides, with one of the monomers being ethylene oxide. Preferably the further monomer beside ethylene oxide is propylene oxide and/or 1,2-butylene oxide, preferably only 1,2-propylene oxide.

Also suitable backbones are those that start with a hereinafter named “core” which is an organic compound bearing at least two hydroxy-groups and including water, wherein those hydroxy-groups are then modified with any of the compounds for producing the first structural unit to produce backbone-polymers as defined hereinbefore at the start of the description of the “first structural unit”, which deviate from the structures of the beforementioned backbones only by the additional “insertion” of the core into the before defined structure. Such suitable cores are glycerine, 2-methyl-1,3-propanediol, neopenthylglycol, diethyleneglycol, triethyleneglycol, dipropylene glycol, 1,3-propanediol, 1,3-butanediol, trismethylol propane, water, pentaerythritol, sorbitol, saccharose, glucose, fructose, lactose, and similar compounds having a similar chemical structure. Possible in principle are also diamines such as ethylene-diamine, propylenediamine, die-ethylenetriamine, di-propylenetriamine etc., but those amines are not preferred in view of potential problems with ecotoxicity, especially when released again from the polymer structures upon bio-degradation of the inventive graft polymers.

However, the use of such cores to prepare the backbones for use as first structural unit in this invention are not preferred.

In a further embodiment, the amount of ethylene oxide in the polymer backbone A is within 10-100 weight percent (in relation to the total molar amount of alkylene oxides in the polymer backbone (A)). More preferably, the monomers in the polymer backbone stem from the use of ethylene oxide and optionally at least one further monomer selected from 1,2 propylene oxide (PO) and 1,2-butylene oxide, preferably only PO, with the amount of ethylene oxide in the polymer backbone A being within 10 to 100, preferably 10-90, more preferably at least thirty, even more preferably at least 50, even more preferably at least 70, most preferably at least 80 weight percent (in relation to the total amount of alkylene oxides in the polymer backbone (A)).

Thus, preferred polymer backbones (A) are selected from i) poly (ethylene oxide), and ii) polyalkylene oxide comprising only ethylene oxide (EO) and propylene-oxide (PO), preferably a EO/PO/EO triblock polymer, a PO/EO/PO triblock polymer or a random EO/PO copolymer, more preferably a EO/PO/EO triblock polymer or a PO/EO/PO triblock polymer, and most preferably a PO/EO/PO triblock polymer, with PO/EO/PO being overall preferred over—in descending order-random-EO/PO>100% EO>EO/PO/EO.

It is noted that any of the alkylene oxides used to prepare the backbones of the first structural unit may be derived from a fossil or non-fossil carbon source or even a mixture thereof. Preferably, the amount of non-fossil carbon atoms in the alkylene oxide employed is at least 10%, at least 20%, at least 40%, at least 70%, at least 95% and most preferably up top 100% based on non-fossil derived carbon atoms; the same applies to the total inventive compound as such. The skilled person is well-aware of commercial alkylene oxide products made of non-fossil carbon sources (these products are often sold as being “sustainable”, “renewable” or “bio-based”). For example, Croda International, Snaith, UK, sells ethylene oxide and related products based on bio-ethanol as “ECO”-Range. Ad-ditionally, methods to prepare bio-based propylene oxide are also known (see Abraham, D. S., “Production of propylene oxide from propylene glycol” Master's Thesis University of Missouri-Columbia (2007) (75 pages)). The same is of course also true for the starter molecules to be used as “core” as detailed before: those diol-structures of course can be derived from natural, renewable sources and thus be obtained from bio-based raw materials. Such materials and processes are known. Preferably, the amount of non-fossil carbon atoms in the starter molecules to be used as “core” employed is at least 10%, at least 20%, at least 40%, at least 70%, at least 95% and most preferably up top 100% based on non-fossil derived carbon atoms; the same applies to the total inventive compound as such.

The molecular weight of the polymer backbone (A) as given as “Mn” (number average molecular weight) in g/mol is within 400 to 12000, preferably not more than 8000, more preferably not more than 6000, even more preferably not more than 4000, further even more preferably not more than 3000, and at least 400, more preferably at least 500, and with all ranges being made up by combining any number detailed before for the lower border with any number detailed before as the upper border being understood to be comprised as inventive ranges. As more preferred range the Mn is from is from 400 to 4000, even more preferred from 400 to 3000.

The polymer backbone (A) is optionally capped at one or both end groups, the capping is done by C1-C25-alkyl groups using known techniques, preferably C1 to C4-groups.

In a preferred embodiment the polymer backbone (A) is not capped but bears hydroxy-groups at the chain ends.

The second structural unit of the graft polymer are polymeric side chains (B), which are grafted onto the polymer backbone (A), wherein said polymeric sidechains (B) are obtainable by co-polymerization of at least one monomer of (B1) and at least one monomer of (B2): Monomers (B1) are being selected from at least one olefinically unsaturated amine-containing monomer, being preferably 1-vinylimidazole or its derivative such as alkyl-substituted derivatives of 1-vinylimidazole such as 2-methyl-1-vinylimidazole, more preferably being only 1-vinylimidazole, Monomer (B2) are being selected from at least one nitrogen-containing monomer not being a monomer (B1), being preferably a vinyllactame-monomer, more preferably selected from N-vinyllactams, such as N-vinylpyrrolidone, N-vinylpiperidone, N-vinylcaprolactam, even more preferably N-vinylpyrrolidone, N-vinylcaprolactam, and most preferably N-vinylpyrrolidone,
Further monomers may be employed as optional monomers, such as any one or more of 1-vinyl oxazolidinone and other vinyl oxazolidinones, 4-vinyl pyridine-N-oxide, N-vinyl formamide (and its amine if hydrolyzed after polymerization), N-vinyl acetamide, N-vinyl-N-methyl acetamide, acrylamide, methyl acrylamide, N,N′-di alkyl (meth) acrylamide.

However, neither monomers (B1) and (B2) nor the further monomers do comprise a vinyl ester monomer, i.e. no vinyl acetate, vinyl propionate and vinyl laurate and any other known vinyl ester monomer etc are employed to obtain the graft polymer of this invention.

The amount of further monomer(s) is from 0 to 5, preferably at most 2, more preferably 0, but in all cases at most 50% of the amount of (B1), and not more than the amount of (B2).

However, if any other monomers besides the monomers according to (B1), (B2) and optionally further monomers are present, such other monomers are present preferably in an amount of less than 2% of the total amount of monomers employed for obtaining the polymeric sidechains (B), and are preferably present only as impurities but not deliberately added for polymerisation. Preferably, the amount of said other monomers is less than 1, more preferably less than 0.5% by weight, even more preferably less than 0.01% by weight, most preferably there is essentially no or even a total absence of any other monomer besides the monomers (B1), (B2) and optional further monomers.

The inventive graft polymers as detailed before in their composition, their preferred, more preferred etc., most preferred compositions contain the first and the second structural unit in the following amounts—each in weight percent being based on the total WEIGHT OF THE GRAFT POLYMER:
the amount of the polymer backbone (A) is from 70 to 95, preferably 73 to 90, more preferably 73 to 87, even more preferably 75 to 85, and most preferably 77 to 85, and
the amount of polymeric side chains (B) is from 5 to 30, preferably 10 to 27, more preferably 13 to 27 even more preferably 15 to 25, most preferably 15 to 23, and
the amount of (B1) is at least 4 and up to 29, and
the amount of (B2) is at least 1 and up to 15,
with the amount of (B2) in relation to (B1) being in all cases not more than 4-times, preferably not more than 3-times, more preferably not more than 2-times, even more preferably the same amount, and preferably at least 5%, more preferably at least 10%, even more preferably at least 25%, even more preferably at least 50, even more preferably at least 75% as/of the amount of (B1), and
the amount of further monomer(s) is from 0 to 5, preferably at most 2, more preferably 0, but in all cases at most 50% of the amount of (B1), and not more than the amount of (B2).

It is to be understood that the amounts for (A), (B), (B1), (B2) and that for the further monomers may be selected from the various detailed ranges given independently, i.e. lower and upper borders may be combined also from two different ranges given to result in a numerical range nt specified in numbers, such combined range for e.g. (A), (B), (B1), (B2) or that for the further monomers however being explicitly intended to be encompassed by this present invention.

Also, broad ranges and very particularly preferred narrow ranges may be combined in one embodiment of this invention, with the selection of the ranges for one component being independent of that for the other component, in as far as the overall numbers add up to a “100%-polymer”: e.g. the most preferred range for (A) and (B) may be chosen and combined with the broadest possible ranges given for (B1)/(B 2), and any other possible combination.

Preferably, for all selections possible to be made for (A)/(B) and (B1)/(B2)/(further monomers) the same selections are to be made, e.g. all “preferred” ranges are chosen, or—more preferably-all “more preferred” ranges are chosen, or—most preferably-all “most preferable” ranges are chosen.

Hence, in a more preferred embodiment the following amounts are chosen—each in weight percent being based on the total WEIGHT OF THE GRAFT POLYMER:
the amount of the polymer backbone (A) is from 75 to 85, and most preferably 77 to 85, and
the amount of polymeric side chains (B) is from 15 to 25, most preferably 15 to 23, and
the amount of (B1) is at least 6 and up to 24, more preferably up to 20, even more preferably up to 15, even more preferably up to 12, and most preferably at least 7.5 and up to 10, and
the amount of (B2) is at least 1 and up to 15, more preferably up to 13, even more preferably up to 12, even more preferably up to 11, and most preferably at least 7.5 and up to 10, and more preferably with the amount of (B2) in relation to (B1) being the same amount however without exceeding the total upper or lower limit of (B).

In another embodiment the following amounts are chosen—each in weight percent being based on the total WEIGHT OF THE GRAFT POLYMER:
the amount of the polymer backbone (A) is from 75 to 85, and most preferably 77 to 85, and
the amount of polymeric side chains (B) is from 15 to 25, most preferably 15 to 23, and
the amount of (B1) is at least 6 and up to 24, more preferably up to 20, even more preferably up to 15, even more preferably up to 12, and most preferably at least 7.5 and up to 10, and
the amount of (B2) is at least 1 and up to 15, more preferably up to 13, even more preferably up to 12, even more preferably up to 11, and most preferably at least 7.5 and up to 10, and
preferably the amount of (B2) in relation to (B1) in all cases being at most 75%, even more preferably at most 50%, and most preferably at most 25%, as/of the amount of (B1).

In a preferred embodiment, the graft polymer as disclosed herein and specifically as detailed in the embodiments before wherein the
(A) the polymer backbone (A) is a tri-block polymer EO/PO/EO, the molecular weight of the polymer backbone (A) as Mn in g/mol is within 400 to 3000, with the relative amount of EO in the polymer backbone (A) being within 10-90, preferably 10 to 60, more preferably 15 to 50 weight percent in relation to the total molar amount of alkylene oxides in the polymer backbone and (A),
(B) the polymeric side chains consist of the following monomers:
   B1 is 1-vinyl imidazole, and
   B2 is a N-vinyllactame, preferably is N-vinylpyrrolidone.

In a more preferred embodiment, the graft polymer as detailed before is a polymer comprising
(A) the polymer backbone (A) which is a tri-block polymer EO/PO/EO, and the molecular weight of the polymer backbone (A) as Mn in g/mol is within 400 to 3000, with the relative amount of EO in the polymer backbone (A) being within 10-90, preferably 10 to 60, more preferably 15 to 50 weight percent in relation to the total molar amount of alkylene oxides in the polymer backbone (A) and
(B) the polymeric side chains which consist of the following monomers:
   B1 is 1-vinyl imidazole, and
   B2 is a N-vinyllactame, preferably is N-vinylpyrrolidone,
wherein—each in weight percent being based on the total WEIGHT OF THE GRAFT POLYMER—
   the amount of the polymer backbone (A) is from 70 to 95, preferably 73 to 90, more preferably 73 to 87, even more preferably 75 to 85, and most preferably 77 to 85, and
   the amount of polymeric side chains (B) is from 5 to 30, preferably 10 to 27, more preferably 13 to 27 even more preferably 15 to 25, most preferably 15 to 23, and
   the amount of (B1) is at least 4 and up to 29, and
   the amount of (B2) is at least 1 and up to 15,
   with the amount of (B2) in relation to (B1) being in all cases not more than 4-times, preferably not more than 3-times, more preferably not more than 2-times, even more preferably the same amount, and preferably at least 5%, more preferably at least 10%, even more preferably at least 25%, even more preferably at least 50, even more preferably at least 75% as/of the amount of (B1), and
   the amount of further monomer(s) is from 0 to 5, preferably at most 2, more preferably 0, but in all cases at most 50% of the amount of (B1), and not more than the amount of (B2).

In an even more preferred embodiment, the preferred selections for the polymer compositions as detailed before in the two preceeding paragraphs, and the preferred selections for the amounts as detailed before, are combined.

In an even more preferred embodiment, the graft polymer as detailed before is a polymer comprising
(A) the polymer backbone (A) which is a tri-block polymer EO/PO/EO, and the molecular weight of the polymer backbone (A) as Mn in g/mol is within 400 to 3000, with the relative amount of EO in the polymer backbone (A) being within 10-90, preferably 10 to 60, more preferably 15 to 50 weight percent in relation to the total molar amount of alkylene oxides in the polymer backbone (A)
and
(B) the polymeric side chains which consist of the following monomers:
   B1 is 1-vinyl imidazole, and
   B2 is a N-vinyllactame, preferably is N-vinylpyrrolidone,
wherein—each in weight percent being based on the total WEIGHT OF THE GRAFT POLYMER—
   the amount of the polymer backbone (A) is from 70 to 95, preferably 73 to 90, more preferably 73 to 87, even more preferably 75 to 85, and most preferably 77 to 85, and
   the amount of polymeric side chains (B) is from 5 to 30, preferably 10 to 27, more preferably 13 to 27 even more preferably 15 to 25, most preferably 15 to 23, and
   the amount of (B1) is at least 4 and up to 29, and
   the amount of (B2) is at least 1 and up to 15,
   with the amount of (B2) in relation to (B1) being in all cases not more than 4-times, preferably not more than 3-times, more preferably not more than 2-times, even more preferably the same amount, and preferably at least 5%, more preferably at least 10%, even more preferably at least 25%, even more preferably at least 50, even more preferably at least 75% as/of the amount of (B1), and most preferably with the amount of (B2) in relation to (B1) being the same amount however without exceeding the total upper or lower limit of (B), and
   the amount of further monomer(s) is from 0 to 5, preferably at most 2, more preferably 0, but in all cases at most 50% of the amount of (B1), and not more than the amount of (B2).

In an even more preferred embodiment, the preferred selections possible for the various variables for the polymer compositions as detailed before in the preceeding paragraph, are chosen and combined.

In an even more preferred embodiment than the one before, the more preferred selections possible for the various variables for the polymer compositions as detailed before in the pre-preceeding paragraph, are chosen and combined.

In an even more preferred embodiment than the one before, the most preferred selections possible for the various variables for the polymer compositions as detailed before in the pre-pre-preceeding paragraph, are chosen and combined.

In another—not so preferred-embodiment the following amounts are chosen—each in weight percent being based on the total WEIGHT OF THE GRAFT POLYMER:
the amount of the polymer backbone (A) is from 75 to 85, and most preferably 77 to 85, and
the amount of polymeric side chains (B) is from 15 to 25, most preferably 15 to 23, and
the amount of (B1) is at least 6 and up to 24, more preferably up to 20, even more preferably up to 15, even more preferably up to 12, and most preferably at least 7.5 and up to 10, and
the amount of (B2) is at least 1 and up to 15, more preferably up to 13, even more preferably up to 12, even more preferably up to 11, and most preferably at least 7.5 and up to 10, and
preferably the amount of (B2) in relation to (B1) in all cases being at most 75%, even more preferably at most 50%, and most preferably at most 25%, as/of the amount of (B1).

The inventive graft polymer as detailed before has a polydispersity (PDI) Mw/Mn of up to 3, preferably up to 2.5, more preferably up to 2, (with Mw=weight average molecular weight in g/mol, and Mn=number average molecular weight in g/mol; with the PDI being unitless), with lower numbers being preferred, but depending on the Mn of the polymer backbone employed (the higher the Mn of (A) also typically the higher the PDI) and also on the amount of (B) (the higher the amount of (B) relative to the amount of (A) typically the higher the PDI).

The respective values of Mw and Mn can be determined as described within the experimental section below.

The graft polymers of the invention may contain a certain amount of ungrafted polymers (“ungrafted side chains”) made of monomers not being reacted with (i.e. grafted (on-) to) the polymer backbone. The amount of such ungrafted polymers may be high or low, depending on the reaction conditions, but is preferably to be lowered and thus is more preferably low. By this lowering, the amount of grafted side chains is preferably increased. Such lowering can be achieved by suitable reaction conditions, such as dosing of monomers and radical initiator and their relative amounts and also in relation to the amount of backbone being present. Such adjustment is in principle known to a person of skill in the present field, and detailed hereinafter for this present invention within the description of a process to obtain the inventive graft polymers.

It has been found that the inventive graft polymers as detailed herein before exhibit an improved bio-degradability which is at least 40, more preferably at least 45, such as 46, 47, 48, 49, 50, 55, 60, 65, etc and any number in between and up to 100%, within 28 days when tested under OECD 301F.

### Process

The invention also encompasse a process for obtaining a graft polymer according to one of claims 1 to 7, wherein the at least one monomer B1, the at least one monomer B2, and the optional at least one further monomer(s) are polymerized in the presence of at least one polymer backbone (A), wherein the polymeric sidechains (B) are obtained by radical polymerization, using radical forming compounds to initiate the radical polymerization, each B, B1, B2 and A as detailed herin before and exemplified in the examples below.

It has to be noted that the “grafting process” as such, wherein a polymeric backbone, such as the polymer backbone (A) described herein above, is grafted with polymeric sidechains, is known to a person skilled in the art. Any process known to the skilled person in this respect can in principle be employed within the present invention.

The radical polymerization as such is also known to a skilled person. That person also knows that the inventive process can be carried out in the presence of a radical-forming initiator (C) and/or at least one solvent (D). The skilled person knows the respective components suitable as such.

The term “radical polymerization” as used within the context of the present invention comprises besides the free radical polymerization also variants thereof, such as controlled radical polymerization. Suitable control mechanisms are RAFT, NMP or ATRP, which are each known to the skilled person, including suitable control agents.

In a preferred embodiment the process to obtain the graft polymer of the invention as detailed herein before comprise the steps of polymerization of
i) at least one monomer (B1),
ii) at least one monomer (B2),
iii) optionally at least one further monomer
   in the presence of at least one polymer backbone (A)
   (with B1, B2, optional further monomer(s) and A as detailed herein before and hereinafter in their respective ranges including the respective “preferred”, “more preferred” etc “most preferred” ranges, amounts and selections and the combinations thereof as described in detail above),
iv) a free radical-forming initiator (C) and,
v) optionally in the presence at least one solvent (D), which is present in amounts of up to 60%, preferably up to 50%, by weight based on the sum of components (A), (B1), (B2), optional further monomers, and (C), preferably in the presence of solvent, such solvent preferably comprising water and up to 20 percent, more preferably up to 10, even more preferably up to 5, and most preferably less than 3, 2 or even 1 volume percent organic solvent(s) by total volume of all solvents, and even more preferably the solvent (D) used for the polymerization reaction is water only, with most preferably the radical initiator being dissolved in such small amounts of organic solvents as needed only for introducing the radical initiator C, such solvents for dissolving as disclosed hereinafter,
   in a main polymerization reaction step at a mean polymerization temperature at which the initiator (C) has a decomposition half-life of from 40 to 500 min,
   optionally performing at least one further polymerization step to reduce the amount of unreacted monomer(s) (“post-polymerisation”), and
   optionally performing at least one purification step selected from thermal or vacuum distillation or stripping with a gas such as steam or nitrogen, preferably stripping with steam made from water, all at ambient or reduced pressure, in order to remove volatile components such as volatile solvents and unreacted monomers, and optionally performing a drying step.

Preferably, the embodiment immediately before is performed in such a way that
in Version A) of this embodiment—the fraction of unconverted graft monomers (B1, B2 and optional further monomer(s)) and initiator (C) in the reaction mixture is constantly kept in a quantitative deficiency relative to the polymer backbone (A),
   whereas in Version B) of this embodiment, the fraction of unconverted graft monomers (B1, B2 and optional further monomer(s)) is higher and as specified below at the start of the polymerization reaction instead of keeping the monomers in a quantitative deficiency. Preferably, in version B the polymerization reaction is performed in such a way that the fraction of unconverted graft monomers B1, B2 and optional further monomer(s)) at the time when affecting the polymerization reaction is at least more than 5, preferably more than 20, even more preferably more than 50, even more preferably more than 75, even more preferably more than 90, and most preferably up to 100 percent.

In version A the grafting efficiency is higher, however the performance upon biodegradation and washing performance as tested in the examples herein is comparable.

In a more preferred embodiment, version A is preferred over version B.

In another preferred embodiment of this invention, and more preferably in a preferred version of any of the previous process embodiments, the solvent is selected from at least one organic solvent and water (D), such solvent which is present in amounts of up to 60%, preferably up to 50%, by weight based on the sum of components (A), (B1), (B2), optional further monomers, (C) and (D), such solvent (D) preferably comprising water and up to 20 percent, more preferably up to 10, even more preferably up to 5, and most preferably less than 3, 2 or even 1 volume percent organic solvent(s) by total weight percent of the polymer consisting of {(A)+ (B1)+ (B2)+optional further monomers}.

“Low concentration of graft monomers” (identical in its meaning to “quantitative deficiency”) means for preferred embodiment A) in this respect a concentration of about 0.1 to up to 5 weight percent, more preferably up to 3, even more preferably 1, even more preferably up to 0.5 percent by weight or less of the total amount of each monomer to be added, whereas for embodiment B) the fraction of unconverted monomers (B1, B2 and optional further monomers) is at least it means more than 5, preferably more than 20, even more preferably more than 50, even more preferably more than 75, even more preferably more than 90, and most preferably up to 100 percent.

According to the invention in embodiment A), the polymerization is carried out in such a way that an excess of polymer (polymer backbone (A) and formed graft polymer (B)) is constantly present in the reactor.

“Per total weight of the graft polymer” means the total content of polymer within the reaction mixture, regardless if the polymer being created is actually grafted or not.

The amount of ((free) radical-forming) initiator (C) is preferably from 0.1 to 5% by weight, in particular from 0.3 to 3.5% by weight, and any number in between, based in each case on the total weight of the graft polymer.

For the process according to the invention, it is preferred that the steady-state concentration of radicals present at the mean polymerization temperature is substantially constant and the graft monomers (B1) and/or (B2) are present—in the first preferred embodiment A) above—in the reaction mixture constantly only in low concentration. This allows the reaction to be controlled, and graft polymers can be prepared in a controlled manner with the desired low polydispersity.

In the preferred embodiment B) above it is as well preferred that the steady-state concentration of radicals present at the mean polymerization temperature is substantially constant. To assure a safe temperature control although a large or all amounts of the monomers are present from the start of the polymeriszaziton temperature, it is advisable, and thus preferred, to use an additional and efficient measure to control the temperature. This can be done by external or internal cooling; such cooling can be done by internal or external coolers such as heat exchangers, or using reflux condensors when working at the boiling temperature of the solvent or the solvent mixture.

The same measure could of course be used for the alternatively preferred embodiment A) as well, but for A) this is usually not a crucial point, as the temperature is at least partially controlled also by the propagation of the polymerization reaction by controlling the radical concentration and the available amount of polyerizable monomers.

Of course, depending on the scale of the polymerisation reaction, such additional cooling as described before may become necessary for both variants A) and B) when the scale gets large enough that the ratio from volume to surface of the polymerization mixture becomes very large.

This however is generally known to a person of skill in the art of commercial scale polymerisations, and thus can be adapted to the needs.

The term “mean polymerization temperature” is intended to mean here that, although the process is substantially isothermal, there may, owing to the exothermicity of the reaction, be temperature variations which are preferably kept within the range of +/−10° C., more preferably in the range of +/−5° C.

According to the invention, the (radical-forming) initiator (C) at the mean polymerization temperature should have a decomposition half-life of from 40 to 500 min, preferably from 50 to 400 min and more preferably from 60 to 300 min.

According to the invention, the initiator (C) and the graft monomers (B1), (B2) and optional further monomer(s) are advantageously added in such a way that a low and substantially constant concentration of undecomposed initiator and graft monomers (B1), (B2) and optional further monomer(s) is present in the reaction mixture.

The proportion of undecomposed initiator in the overall reaction mixture is preferably up to 15% by weight, in particular up to 10% by weight, based on the total amount of initiator metered in during the monomer addition. The mean polymerization temperature is appropriately in the range from 50 to 140° C., preferably from 60 to 120° C. and more preferably from 65 to 110° C.

Examples of suitable initiators (C) whose decomposition half-life in the temperature range from 50 to 140° C. is from 20 to 500 min are:

O—C₂-C₁₂-acylated derivatives of tert-C₄-C₁₂-alkyl hydroperoxides and tert-(C₉-C₁₂-aralkyl)-hydroperoxides, such as tert-butyl peroxyacetate, tert-butyl monoperoxymaleate, tert-butyl peroxyisobutyrate, tert-butyl peroxypivalate, tert-butyl peroxyneoheptanoate, tert-butyl peroxy-2-ethylhexanoate, tert-butyl peroxy-3,5,5-trimethylhexanoate, tert-butyl peroxyneodecanoate, tert-amyl peroxypivalate, tert-amyl peroxy-2-ethylhexanoate, tert-amyl peroxyneodecanoate, 1,1,3,3-tetramethylbutyl peroxyneodecanoate, cumyl peroxyneodecanoate, tert-butyl peroxybenzoate, tert-amyl peroxybenzoate and di-tert-butyl diperoxyphthalate;
di-O—C₄-C₁₂-acylated derivatives of tert-C₈-C₁₄-alkylene bisperoxides, such as 2,5-dimethyl-2,5-di (2-ethylhexanoylperoxy) hexane, 2,5-dimethyl-2,5-di (benzoylperoxy) hexane and 1,3-di (2-neodecanoylperoxyisopropyl)benzene;
di (C₂-C₁₂-alkanoyl) and dibenzoyl peroxides, such as diacetyl peroxide, dipropionyl peroxide, disuccinyl peroxide, dicapryloyl peroxide, di (3,5,5-trimethylhexanoyl) peroxide, didecanoyl peroxide, dilauroyl peroxide, dibenzoyl peroxide, di (4-methylbenzoyl) peroxide, di (4-chlorobenzoyl) peroxide and di (2,4-dichlorobenzoyl) peroxide;
tert-C₄-C₅-alkyl peroxy (C₄-C₁₂-alkyl) carbonates, such as tert-amyl peroxy (2-ethyl-hexyl) carbonate;
di (C₂-C₁₂-alkyl) peroxydicarbonates, such as di (n-butyl) peroxydicarbonate and di (2-ethylhexyl) peroxydicarbonate.

Depending on the mean polymerization temperature, examples of particularly suitable initiators (C) are:
at a mean polymerization temperature of from 50 to 60° C.: tert-butyl peroxyneoheptanoate, tert-butyl peroxyneodecanoate, tert-amyl peroxypivalate, tert-amyl peroxyneodecanoate, 1,1,3,3-tetramethylbutyl peroxyneodecanoate, cumyl peroxyneodecanoate, 1,3-di (2-neodecanoyl peroxyisopropyl)benzene, di (n-butyl) peroxydicarbonate and di (2-ethylhexyl) peroxydicarbonate;
at a mean polymerization temperature of from 60 to 70° C.: tert-butyl peroxypivalate, tert-butyl peroxyneoheptanoate, tert-butyl peroxyneodecanoate, tert-amyl peroxypivalate and di (2,4-dichlorobenzoyl) peroxide;
at a mean polymerization temperature of from 70 to 80° C.: tert-butyl peroxypivalate, tert-butyl peroxyneoheptanoate, tert-amyl peroxypivalate, dipropionyl peroxide, dicapryloyl peroxide, didecanoyl peroxide, dilauroyl peroxide, di (2,4-dichlorobenzoyl) peroxide and 2,5-dimethyl-2,5-di (2-ethylhexanoylperoxy) hexane;
at a mean polymerization temperature of from 80 to 90° C.: tert-butyl peroxyisobutyrate, tert-butyl peroxy-2-ethylhexanoate, tert-amyl peroxy-2-ethylhexanoate, dipropionyl peroxide, dicapryloyl peroxide, didecanoyl peroxide, dilauroyl peroxide, di (3,5,5-trimethylhexanoyl) peroxide, dibenzoyl peroxide and di (4-methylbenzoyl) peroxide;
at a mean polymerization temperature of from 90 to 100° C.:
tert-butyl peroxyisobutyrate, tert-butyl peroxy-2-ethylhexanoate, tert-butyl monoperoxymaleate, tert-amyl peroxy-2-ethylhexanoate, dibenzoyl peroxide and di (4-methylbenzoyl) peroxide;
at a mean polymerization temperature of from 100 to 110° C.: tert-butyl monoperoxymaleate, tert-butyl peroxyisobutyrate and tert-amyl peroxy (2-ethylhexyl) carbonate;
at a mean polymerization temperature of from 110 to 120° C.:
tert-butyl monoperoxymaleate, tert-butyl peroxy-3,5,5-trimethylhexanoate and tert-amyl peroxy (2-ethylhexyl) carbonate.

Preferred initiators (C) are O—C₄-C₁₂-acylated derivatives of tert-C₄-C₅-alkyl hydroperoxides, particular preference being given to tert-butyl peroxypivalate and tert-butyl peroxy-2-ethylhexanoate.

Particularly advantageous polymerization conditions can be established effortlessly by precise adjustment of initiator (C) and polymerization temperature. For instance, the preferred mean polymerization temperature in the case of use of tert-butyl peroxypivalate is from 60 to 90° C., and, in the case of tert-butyl peroxy-2-ethylhexanoate, from 80 to 100° C.

Further examples of suitable initiators (C) are also azo-inititiaors having a comparable decomposition half-life in the temperature range from 50 to 140° C. is from 20 to 500 min, such as the ones available from the company WAKO (i.e. Fujifilm Wako), such V-50 as (2,2′-azobis (2-methylpropionamidin)dihydrochloride), V-59 (2,2′-azobis (2-methylbutyronitrile)), V-601 and V-601HP (dimethyl 2,2′-azobis (2-methylpropionate)), VA-086 (2,2′-Azobis[2-methyl-N-(2-hydroxyethyl) propionamide]), V-501 (4,4′-Azobis (4-cyanovaleric acid)), VA-057 (2,2′-Azobis[N-(2-carboxyethyl)-2-methyl propionamidine] tetrahydrate), V-40 (1,1′-Azobis (cyclohexane-1-carbonitrile)), AIBN and AIBN-HP (2,2′-Azobis (isobutyronitrile)), V-65 and V-65HP (2,2′-Azobis (2,4-VAm-110 dimethylvaleronitrile)), (2,2′-Azobis (N-butyl-2-methylpropionamide)), VR-110 (2,2′-Azobis (2,4,4-trimethylpentane)), VPE-0201 (see structure)—and of course the same chemical compounds available from other sources.

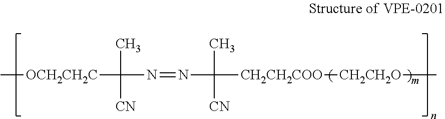

Preferred are the oil-soluble V-601, V-70, V-40, AIBN, V-65, Vam-110, VR-110, V-59, V 50, with V-59 more preferred among the oil-soluble azo-initiators, and the water-soluble VA-44, VA-057, V-50, V-501 and VA-086, with V-50 and V-501 being more preferred among the water-soluble azo-initiators, and with the water-soluble azo-initiators more preferred than the oil-soluble azo-intiators.

Most preferred initiators are tert-butyl peroxy pivalate and (2,2′-azobis (2-methylpropionamidin)dihydrochloride).

In a preferred embodiment of the inventive process, the amount of ((free) radical-forming) initiator (C) is from 0.1 to 5% by weight, in particular from 0.3 to 3.5% by weight, based in each case on the total weight of the graft polymer.

The inventive polymerization reaction can be carried out in the presence of an solvent (D). It is of course also possible to use mixtures of different solvents (D), including mixtures of organic solvents, and mixtures of organic solvents with water or water only. Preference is given to using water-soluble or water-miscible solvents.

When a solvent (D) is used as a diluent, generally from 1 to 40% by weight, preferably from 1 to 35% by weight, more preferably from 1.5 to 30% by weight, most preferably from 2 to 25% by weight, based in each case on the sum of the components (A), (B1), optionally (B2), and (C), are used.

Examples of suitable solvents (D) include:
monohydric alcohols, preferably aliphatic C₁-C₁₆-alcohols, more preferably aliphatic C₂-C₁₂-alcohols, most preferably C₂-C₄-alcohols, such as ethanol, propanol, isopropanol, butanol, sec-butanol and tert-butanol;
polyhydric alcohols, preferably C₂-C₁₀-diols, more preferably C₂-C₆-diols, most preferably C₂-C₄-alkylene glycols, such as ethylene glycol, 1,2-propylene glycol and 1,3-propylene glycol;
alkylene glycol ethers, preferably alkylene glycol mono (C₁-C₁₂-alkyl) ethers and alkylene glycol di (C₁-C₆-alkyl) ethers, more preferably alkylene glycol mono- and di (C₁-C₂-alkyl) ethers, most preferably alkylene glycol mono (C₁-C₂-alkyl) ethers, such as ethylene glycol monomethyl and -ethyl ether and propylene glycol monomethyl and -ethyl ether;
polyalkylene glycols, preferably poly (C₂-C₄-alkylene) glycols having 2-20 C₂-C₄-alkylene glycol units, more preferably polyethylene glycols having 2-20 ethylene glycol units and polypropylene glycols having 2-10 propylene glycol units, most preferably polyethylene glycols having 2-15 ethylene glycol units and polypropylene glycols having 2-4 propylene glycol units, such as diethylene glycol, triethylene glycol, dipropylene glycol and tripropylene glycol;
polyalkylene glycol monoethers, preferably poly (C₂-C₄-alkylene) glycol mono (C₁-C₂₅-alkyl) ethers having 2-20 alkylene glycol units, more preferably poly (C₂-C₄-alkylene) glycol mono (C₁-C₂₀-alkyl) ethers having 2-20 alkylene glycol units, most preferably poly (C₂-C₃-alkylene) glycol mono (C₁-C₁₆-alkyl) ethers having 3-20 alkylene glycol units;
carboxylic esters, preferably C₁-C₈-alkyl esters of C₁-C₆-carboxylic acids, more preferably C₁-C₄-alkyl esters of C₁-C₃-carboxylic acids, most preferably C₂-C₄-alkyl esters of C₂-C₃-carboxylic acids, such as ethyl acetate and ethyl propionate;
aliphatic ketones which preferably have from 3 to 10 carbon atoms, such as acetone, methyl ethyl ketone, diethyl ketone and cyclohexanone;
cyclic ethers, in particular tetrahydrofuran.

The solvents (D) are advantageously those solvents, which are also used to formulate the inventive graft polymers for use (for example in washing and cleaning compositions) and can therefore remain in the polymerization product.

Preferred examples of these solvents are polyethylene glycols having 2-15 ethylene glycol units, polypropylene glycols having 2-6 propylene glycol units and in particular alkoxylation products of C₆-C₈-alcohols (alkylene glycol monoalkyl ethers and polyalkylene glycol monoalkyl ethers).

Particular preference is given here to alkoxylation products of C₈-C₁₆-alcohols with a high degree of branching, which allow the formulation of polymer mixtures which are free-flowing at 40-70° C. and have a very low polymer content at comparatively low viscosity. The branching may be present in the alkyl chain of the alcohol and/or in the polyalkoxylate moiety (copolymerization of at least one propylene oxide, butylene oxide or isobutylene oxide unit). Particularly suitable examples of these alkoxylation products are 2-ethylhexanol or 2-propylheptanol alkoxylated with 1-15 mol of ethylene oxide, C₁₃/C₁₅ oxo alcohol or C₁₂/C₁₄ or C₁₆/C₁₈ fatty alcohol alkoxylated with 1-15 mol of ethylene oxide and 1-3 mol of propylene oxide, preference being given to 2-propylheptanol alkoxylated with 1-15 mol of ethylene oxide and 1-3 mol of propylene oxide.

In a preferred embodiment of the inventive process, at least one organic solvent and/or water (D) is present in amounts of up to 60% by weight based on the sum of components (A), (B1), (B2), optional further monomers, and (C), and (D).

In a preferred embodiment, polymerization is carried our without the use of a solvent (D), except for the solvent needed for introducing the inititator.

In a more preferred embodiment, the solvent (D) used is water, with the radical initiator being dissolved in small amounts of organic solvents as disclosed hereinafter; in case the initiator is also soluble in water, of course the organic solvent can be omitted completely.

Small amounts of organic solvents may be used, and preferably are used, for introducing for example the radical initiator as well as the graft monomers (B1) and/or (B2) which might be soluble to a reasonable extent only in such organic solvents but not in water. Suitable organic solvents may be isopropanol, ethanol, 1,2-propandiol and/or tripropylene glycol, and/or other suitable alcohols or organic solvents like 1-methoxy-2-propanol which are considerably inexpensive and available for large-scale uses, or solvents like ethyl acetate, methyl ethyl ketone, and the like, with isopropanol, 1,2-propandiol, 1-Methoxy-2-propanol, ethyl acetate and/or tripropylene glycol being preferred co-solvents, with ethyl aetate and tripropylene glycol being even more preferred, preferably only introduced in the reaction as solvents for the radical initiator and/or the graft monomers (B1) and/or (B2) in as low amounts as possible, preferably only for the radical initiator(s).

In such cases of low overall amounts of alcohols or other organic solvents compared to water, such organic solvents may be left in the final polymer, preferably may be left when the overall amount based on total solvents is less than 1, preferably less than 0.5, more preferably less than 0.1 weight percent.

For solvents having a boiling point of less than about 110-120° C. at atmospheric pressure, such solvents may be removed partially or essentially complete by thermal or vacuum distillation or stripping with a gas such as steam or nitrogen, preferably stripping with steam made from water, all at ambient or reduced pressure, whereas higher boiling solvents will usually stay in the polymer products obtained. Hence, solvents like 1-methoxy-2-propanol, 1,2-propandiol and tripropylene glycol will stay in the polymer product, and thus their amounts should be minimized as far as possible by using as high as possible concentrations of the radical initiator.

The radical initiator (C) is preferably employed in the form of a concentrated solution in one of the solvents mentioned before. The concentration of course depends on the solubility of the radical initiator. It is preferred, that the concentration is as high as possible to allow to introduce as little as possible of the organic solvent into the polymerization reaction.

The monomers are preferably employed in their pure form, or—not preferred—in the form of a 10 to 95% by weight solution in one of the solvents mentioned before. Here again, it is preferred, that the concentration is as high as possible to allow to introduce as little as possible of the organic solvent into the polymerization reaction.

In the process according to the invention, polymer backbone (A), graft monomer (B1), (B2) and and optional further monomer(s), initiator (C) and, if appropriate, solvent (D) are usually heated to the selected mean polymerization temperature in a reactor.

The polymerization process according to the invention can in principle be carried out in various reactor types.

In a preferred embodiment, the reactor used is preferably a stirred tank in which the polymer backbone (A), if appropriate together with portions, of generally up to 15% by weight of the particular total amount, of graft monomers (B1), (B2) and and optional further monomer(s), initiator (C) and solvent (D), are initially charged fully or partly and heated to the polymerization temperature, and the remaining amounts of (B1), (B2) and and optional further monomer(s), (C) and, if appropriate, (D) are metered in, preferably separately. The remaining amounts of (B1), (B2) and and optional further monomer(s), (C) and, if appropriate, (D) are metered in—in embodiment A)—preferably over a period of at least 1 h, more preferably of at least 2 h and most preferably of at least 3 h, and preferably at most 15, more preferably of not more than 12, even more preferred of not more than 10, even more preferred of not more than 8 hours, such as up to 7, 6, 5, or even 4, with the most preferred range in between about 3 to 7 hours (also depending on the scale of the reaction), whereas in embodiment B) the monomers are added to the reaction zone prior to the addition of the radical initiator in an amount of at least 50, more preferably at least 70, even more preferably at least 90, and most preferably 100 percent of the total amount of each monomer (all amounts of all monomers employed may be selected individually and independently from each other), with the remaining amounts of monomers and radical initiator not added at the start of the polymerization reaction being added as in embodiment A). In case of both embodiment A) and B), the duration of the radical initiator addition is preferably longer than the duration of the monomer addition, by preferably about 0.25 hour, preferably about 0.5 hour, and up to 3 hours.

A post-polymerization process step may be added after the main polymerization reaction. For that a further amount of initiator (dissolved in the solvent(s)) can be added over a period of 0.5 hour and up to 3 hours, preferably about 1 to 2 hours, more preferably about 1 hour, with the radical initiator and the solvent(s) for the initiator typically—and preferred-being the same as the ones for the main polymerization reaction. Of course a different radical initiator and/or different solvent(s) may be employed as well.

In between the post-polymerisation and the main polymerization a certain period of time may be waited, where the main polymerization reaction is left to proceed, before the post-polymerisation reaction is started by starting the addition of further radical initiator.

The temperature of the post-polymerisation process step may be the same as in the main polymerization reaction (which is preferred in this invention), or may be increased. In case increased, it may be typically higher by about 5 to 40° C., preferably 10 to 20° C.

In a further particularly preferred, low-solvent process variant, the procedure is as described above, except that solvent (D) is metered in during the polymerization in order to limit the viscosity of the reaction mixture. It is also possible to commence with the metered addition of the solvent only at a later time with advanced polymerization, or to add it in portions.

The polymerization can be affected under standard pressure or at reduced or elevated pressure. When the boiling point of the monomers (B1), (B2) and optional further monomer(s) or of any solvent (D) used is exceeded at the selected pressure, the polymerization is carried out with reflux cooling.

The graft polymer of this invention may be subjected to a means of concentration and/or drying. The graft polymer solution obtained may be concentrated by removing part of the solvent(s) to increase the solid polymer concentration. This may be achieved by distillation processes such as thermal or vacuum distillation, with thermal distillation or steam distillation preferred, and steam distillation even more preferred, which is performed until the desired solid content is achieved. Such process can be combined with the purification step wherein the graft polymer solution obtained is purified by removing part or all of the volatile components such as volatile solvents and/or unreacted, volatile monomers, by removing the desired amount of solvent.

The graft polymer solution may be also after the main and the optional post-polymerization step and the optional purification step dconcentrated or dried by subjecting the graft polymer solution to a means of drying such as roller-drum drying, spray-drying, vacuum drying or freeze-drying, preferably-mainly for cost-reasons-spray-drying. Such drying process may be also combined with an agglomeration or granulation process such as spray-agglomeration or drying in a fluidized-bed dryer and the like.

### Uses

In principle the graft polymers of this invention can be employed in any application to replace known graft polymers of similar composition (however not comprising vinylimidazole) (in terms of relative amounts of polymer backbone and grafted monomers especially when the type and amounts of grafted monomers is comparable, such as graft polymers being referenced in the prior art section of this disclosure. Such applications are for example:
Cosmetics, Personal Care: Such compositions and formulations include shampoos, lotions, gels, sprays, soap, make-up powder, lipsticks, hairspray.
Technical applications: Such compositions and formulations include glues of any kind, non-water and—preferably—water-based liquid formulations or solid formulations, the use as dispersant in dispersions of any kind, such as in oilfield applications, automotive applications, typically where a solid or a liquid is to be dispersed within another liquid or solid.
Lacquer, paints and colorants formulations: Such compositions and formulations include non-water—and—preferably—water-based lacquer and colourants, paints, finishings.
Agricultural Formulations: Such compositions and formulations include formulations and compositions containing agrochemical actives within a liquid, semi-solid, mixed-liquid-solid or solid environment.
Aroma Chemical-formulations: Such compositions and formulations include formulations which dissolve or disperse aroma chemicals in liquid or solid compositions, to evenly disperse and/or retain their stability, so as to retain their aroma profile over extended periods of time; encompassed are also compositions that show a release of aroma chemicals over time, such as extended release or retarded release formulations.

Hence, a subject matter of the present invention is also the use of the above-mentioned graft polymers in
a) cleaning compositions, preferably as additive for liquid, solid or semi-solid detergent formulations, particularly for liquid detergent formulations, preferably concentrated liquid detergent formulations or single mono doses laundry detergent formulations, or liquid hand dish washing detergent formulations or solid automatic dish washing formulations;
b) in fabric and home care products,
c) in agrochemical formulations, preferably as dispersant;
d) as an assistant, for example for production of multilayer composite films, with compatibilization not just of different polymer layers but also of metal foils;
e) as adhesion promoters for adhesives, for example in conjunction with polyvinyl alcohol, butyrate and acetate and styrene copolymers, or as a cohesion promoter for label adhesives;
f) as a primer in coatings applications for improvement of adhesion on substrates such as glass, wood, plastic and metal;
g) for improvement of wet adhesion, for example in standard emulsion paints, and for improvement of instantaneous rain resistance of paints, for example for road markings;
h) as complexing agents, especially with high binding capacity for heavy metals such as Hg, Pb, Cu, Ni;
i) as a penetration aid, for example for active metal salt formulations in wood protection;
j) as corrosion inhibitors, for example for iron and nonferrous metals, and in the sectors of petroleum production and of secondary oil production;
k) for immobilization of proteins and enzymes; microorganisms or as immobilizing supports of enzymes and microorganisms;
l) as fixatives in the picture film-producing industry;
m) as an additive in the cosmetic formulations, for example for hair-setting compositions and hair rinses;
n) as an emulsifier;
o) as a surfactant in the industrial cleaning (IC) sector;
p) for preparation of complexing agents (polycarboxylates);
q) for production of assistants for ore mining and mineral processing;
r) as a dispersant for pigments, ceramic, carbon black, carbon, carbon fibers, metal powders, such as emulsifier or dispersant for inks for e.g. ink jet printing;
s) as a crystallization inhibitor in e.g. agrochemical formulations, oil-field uses;
t) as a rheology modifier;
u) as an assistant or as a component for assistants for the extraction and processing of oil, coal and natural gas;
v) as an additive in coolants, lubricants and cooling lubricants; or
w) as a constituent of galvanizing baths.

Preferably the graft polymers are used in cleaning compositions and/or in fabric and home care products, in particular cleaning compositions for improved dye transfer inhibition, wherein the cleaning composition is preferably a laundry detergent formulation, more preferably a liquid laundry detergent formulation.

The preferred area of application for the use of the graft polymers and the products and compositions comprising the graft polymers is the field of fabric and home care products and cleaning compositions, preferably cleaning compositions for industrial and institutional use and the use by consumers in their household.

Another subject-matter of the present invention is, therefore, also a composition or product for the uses as listed before in this section, in particular a cleaning composition, fabric and home care product, industrial and institutional cleaning product, or agrochemical formulations, preferably in in cleaning compositions and/or in fabric and home care products, more preferably laundry detergents, even more preferably liquid laundry detergents, each comprising at least one graft polymer as defined above or obtained by or obtainable by a process of the invention and/or as detailed herein.

A preferred subject-matter of the present invention is, therefore, a cleaning composition, a fabric and home care product, preferably a laundry cleaning composition, a laundry treatment product or laundry care product or laundry washing product, preferably a liquid laundry detergent formulation or liquid laundry detergent product, containing at least one graft polymer of the invention and/or at least one graft polymer obtained or obtainable by the inventive process, such composition or product exhibiting improved dye transfer inhibition.

Such inventive uses encompass the use of the graft polymer as detailed herein and/or as obtainable from or obtained form the inventive process, such graft polymer resembling that as detailed above describing the polymer structure in all of its embodiments, variations, and preferred, more preferred et. Embodiments, and including also the detailed embodiments as further described in the “Embodiment 1/2/3 etc.” as listed in this description.

In one embodiment it is also preferred that the cleaning composition, fabric and home care product, preferably laundry cleaning composition, a laundry treatment product or laundry care product or laundry washing product, more preferably liquid laundry detergent formulation or liquid laundry detergent product, containing at least one graft polymer of the invention and/or at least one graft polymer obtained or obtainable by the inventive process, such composition or product preferably exhibiting improved dye transfer inhibition properties, additionally comprises at least one enzyme, preferably selected from one or more lipases, hydrolases, amylases, proteases, cellulases, mannanases, hemicellulases, phospholipases, esterases, xylanases, DNases, dispersins, pectinases, oxidoreductases, cutinases, lactases and peroxidases, more preferably at least two of the aforementioned types.

At least one graft polymer as described herein and/or the at least one graft polymer obtained or obtainable by the inventive process as detailed before is present in said inventive compositions and products at a concentration of from about 0.05% to about 20%, preferably 0.05 to 10%, more preferably from about 0.1% to 8%, even more preferably from about 0.2% to about 6%, and further more preferably from about 0.2% to about 4%, and most preferably in amounts of up to 2%, each in weight % in relation to the total weight of such composition or product, and further including all ranges resulting from selecting any of the lower limits and any of the upper limits and all numbers in between those mentioned; such composition or product may—and preferably does—further comprise from about 1% to about 70% by weight of the composition or product of a surfactant system; said compositions, formulations, cleaning compostions and products preferably to be used as or usable as dye transfer inhibitor and/or for inhibiting the transfer of dyes.

Even more preferably, the compositions or products of the present invention as detailed herein before comprising at least one inventive graft polymer as detailed before and/or at least one graft polymer obtained or obtainable by the inventive process as detailed before and in the amounts as specified in the previous paragraph and preferably for use of the graft polymer for inhibition of transfer of dyes, and optionally further comprising at least one surfactant or a surfactant system in amounts from about 1% to about 70% by weight of the composition or product, are those for primary cleaning (i.e. removal of stains) within laundry applications, and may additionally comprise at least one enzyme selected from lipases, hydrolases, amylases, proteases, cellulases, mannanases, hemicellulases, phospholipases, esterases, xylanases, DNases, dispersins, pectinases, oxidoreductases, cutinases, lactases and peroxidases, more preferably at least two of the aforementioned types.

In a preferred embodiment, the cleaning composition of the present invention is a liquid or solid laundry detergent composition, preferably a liquid laundry detergent composition.

In one embodiment, the inventive graft polymers may be utilized in cleaning compositions or products comprising a surfactant system comprising C10-C15 alkyl benzene sulfonates (LAS) as the primary surfactant and one or more additional surfactants selected from non-ionic, cationic, amphoteric, zwitterionic or other anionic surfactants, or mixtures thereof.

In a further embodiment, the inventive graft polymers may be utilized in the cleaning compositions or fabric and home care product, preferably a laundry cleaning composition, a laundry care product or laundry treatment product or laundry washing product, preferably a liquid laundry detergent formulation or liquid laundry detergent product, comprising C8-C18 linear or branched alkyl ethersulfates with 1-5 ethoxy-units as the primary surfactant and one or more additional surfactants selected from non-ionic, cationic, amphoteric, zwitterionic or other anionic surfactants, or mixtures thereof. In a further embodiment the inventive graft polymers may be utilized in cleaning compositions or fabric and home care product, preferably a laundry cleaning composition, a laundry care product or laundry washing product, preferably a liquid laundry detergent formulation or liquid laundry detergent product, comprising C12-C18 alkyl ethoxylate surfactants with 5-10 ethoxy-units as the primary surfactant and one or more additional surfactants selected from anionic, cationic, amphoteric, zwitterionic or other non-ionic surfactants, or mixtures thereof.

In one embodiment of the present invention, the graft polymer is a component of a cleaning compositions or fabric and home care product, preferably a laundry cleaning composition, a laundry care product or laundry treatment product or laundry washing product, preferably a liquid laundry detergent formulation or liquid laundry detergent product, that each additionally comprise at least one surfactant, preferably at least one anionic surfactant.

In a further embodiment, this invention also encompasses a composition, specifically a cleaning composition, more preferably a cleaning composition in liquid, solid or semi-solid form, preferably being a concentrated liquid detergent formulation, single mono doses laundry detergent formulation, liquid hand dish washing detergent formulation or solid automatic dish washing formulation, more preferably a laundry detergent formulation, comprising a graft polymer as described herein before and in the amounts as detailed before, such composition being preferably a detergent composition, such composition further comprising an antimicrobial agent as disclosed hereinafter, preferably selected from the group consisting of 2-phenoxyethanol, more preferably comprising said antimicrobial agent in an amount ranging from 2 ppm to 5% by weight of the composition; even more preferably comprising 0.1 to 2% of phenoxyethanol.

In a further embodiment, this invention also encompasses a method of preserving an aqueous composition against microbial contamination or growth, such composition, specifically a cleaning composition, more preferably a cleaning composition in liquid, solid or semi-solid form, preferably being a concentrated liquid detergent formulation, single mono doses laundry detergent formulation, liquid hand dish washing detergent formulation or solid automatic dish washing formulation, more preferably a laundry detergent formulation, comprising a graft polymer as described herein before and in the amounts detailed before, such composition being preferably a detergent composition, such method comprising adding at least one antimicrobial agent selected from the disclosed antimicrobial agents as disclosed hereinafter, such antimicrobial agent preferably being 2-phenoxyethanol.

In a further embodiment, this invention also encompasses a composition, preferably a cleaning composition, more preferably a liquid laundry detergent composition or a liquid hand dish composition, even more preferably a liquid laundry detergent composition, or a liquid softener composition for use in laundry, such composition comprising a graft polymer in the amounts detailed before and/or a polymer backbone each as described herein before, such composition further comprising 4,4′-dichoro 2-hydroxydiphenylether in a concentration from 0.001 to 3%, preferably 0.002 to 1%, more preferably 0.01 to 0.6%, each by weight of the composition.

In a further embodiment, this invention also encompasses a method of laundering fabric or of cleaning hard surfaces, which method comprises treating a fabric or a hard surface with a cleaning composition, more preferably a liquid laundry detergent composition or a liquid hand dish composition, even more preferably a liquid laundry detergent composition, or a liquid softener composition for use in laundry, such composition comprising a graft polymer in the amounts detailed before and/or a polymer backbone each as described herein before, such composition further comprising 4,4′-dichoro 2-hydroxydiphenylether.

The selection of the additional surfactants and further ingredients (both further described below in the chapter “Cleaning additives”) in these embodiments may be dependent upon the application and the desired benefit.

Description of Cleaning Compositions, Formulations and their Ingredients

The phrase “cleaning composition” as used herein includes compositions and formulations and products designed for cleaning soiled material. Such compositions, formulations and products include those designed for cleaning soiled material or soiled surfaces of any kind.

Compositions for “industrial and institutional cleaning” includes such cleaning compositions being designed for use in industrial and institutional cleaning, such as those for use of cleaning soiled material or surfaces of any kind, such as hard surface cleaners for surfaces of any kind, including tiles, carpets, PVC-surfaces, wooden surfaces, metal surfaces, lacquered surfaces.

“Compositions for Fabric and Home Care” include cleaning compositions including but not limited to laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation, preferably during the wash cycle of the laundering or dish washing operation.

The cleaning compositions of the invention may be in any form, namely, in the form of a liquid; a solid such as a powder, granules, agglomerate, paste, tablet, pouches, bar, gel; an emulsion; types delivered in dual- or multi-compartment containers; single-phase or multi-phase unit dose; a spray or foam detergent; premoistened wipes (i.e., the cleaning composition in combination with a nonwoven material such as that discussed in U.S. Pat. No. 6,121,165, Mackey, et al.); dry wipes (i.e., the cleaning composition in combination with a nonwoven materials, such as that discussed in U.S. Pat. No. 5,980,931, Fowler, et al.) activated with water by a user or consumer; and other homogeneous, non-homogeneous or single-phase or multiphase cleaning product forms.

The liquid cleaning compositions of the present invention preferably have a viscosity of from 50 to 10000 mPa*s; liquid manual dish wash cleaning compositions (also liquid manual “dish wash compositions”) have a viscosity of preferably from 100 to 10000 mPa*s, more preferably from 200 to 5000 mPa*s and most preferably from 500 to 3000 mPa*s at 20 1/s and 20° C.; liquid laundry cleaning compositions have a viscosity of preferably from 50 to 3000 mPa*s, more preferably from 100 to 1500 mPa*s and most preferably from 200 to 1000 mPa*s at 20 1/s and 20° C.

The liquid cleaning compositions of the present invention may have any suitable pH-value. Preferably the pH of the composition is adjusted to between 4 and 14. More preferably the composition has a pH of from 6 to 13, even more preferably from 6 to 10, most preferably from 7 to 9. The pH of the composition can be adjusted using pH modifying ingredients known in the art and is measured as a 10% product concentration in demineralized water at 25° C. For example, NaOH may be used and the actual weight % of NaOH may be varied and trimmed up to the desired pH such as pH 8.0. In one embodiment of the present invention, a pH>7 is adjusted by using amines, preferably alkanolamines, more preferably triethanolamine.

Cleaning compositions such as fabric and home care products and formulations for industrial and institutional cleaning, more specifically such as laundry and manual dish wash detergents, are known to a person skilled in the art. Any composition etc. known to a person skilled in the art, in connection with the respective use, can be employed within the context of the present invention by including at least one inventive polymer, preferably at least one polymer in amounts suitable for expressing a certain property within such a composition, especially when such a composition is used in its area of use.

One aspect of the present invention is also the use of the inventive polymers as additives for detergent formulations, particularly for liquid detergent formulations, preferably concentrated liquid detergent formulations, or single mono doses for laundry.

### Cleaning Additives

The cleaning compositions and formulations of the invention may—and preferably do—contain adjunct cleaning additives (also abbreviated herein as “adjuncts”), such adjuncts being preferably in addition to a surfactant system as defined before.

Suitable adjunct cleaning additives include builders, cobuilders, structurants or thickeners, clay soil removal/anti-redeposition agents, polymeric soil release agents, dispersants such as polymeric dispersing agents, polymeric grease cleaning agents, solubilizing agents, chelating agents, enzymes, enzyme stabilizing systems, bleaching compounds, bleaching agents, bleach activators, bleach catalysts, brighteners, malodor control agents, pigments, dyes, opacifiers, hueing agents, dye transfer inhibiting agents, chelating agents, suds boosters, suds suppressors (antifoams), color speckles, silver care, anti-tarnish and/or anti-corrosion agents, alkalinity sources, pH adjusters, pH-buffer agents, hydrotropes, scrubbing particles, antibacterial agents, anti-oxidants, softeners, carriers, processing aids, pro-perfumes, and perfumes. Alls such adjuncts are detailed and exemplified further below in the following chapters.

Liquid cleaning compositions additionally may comprise—and preferably do comprise at least one of—rheology control/modifying agents, emollients, humectants, skin rejuvenating actives, and solvents. Solid compositions additionally may comprise—and preferably do comprise at least one of—fillers, bleaches, bleach activators and catalytic materials.

Suitable examples of such cleaning adjuncts and levels of use are found in WO 99/05242, U.S. Pat. Nos. 5,576,282, 6,306,812 B1 and 6,326,348 B1.

Those of ordinary skill in the art will understand that a detersive surfactant encompasses any surfactant or mixture of surfactants that provide cleaning, stain removing, or laundering benefit to soiled material. Hence, the cleaning compositions of the invention such as fabric and home care products, and formulations for industrial and institutional cleaning, more specifically such as laundry and manual dish wash detergents, preferably additionally comprise a surfactant system and, more preferably, also further adjuncts, as the one described above and below in more detail.

The surfactant system may be composed from one surfactant or from a combination of surfactants selected from anionic surfactants, non-ionic surfactants, cationic surfactants, zwitterionic surfactants, amphoteric surfactants, and mixtures thereof. Those of ordinary skill in the art will understand that a surfactant system for detergents encompasses any surfactant or mixture of surfactants that provide cleaning, stain removing, or laundering benefit to soiled material.

The cleaning compositions of the invention preferably comprise a surfactant system in an amount sufficient to provide desired cleaning properties. In some embodiments, the cleaning composition comprises, by weight of the composition, from about 1% to about 70% of a surfactant system. In other embodiments, the liquid cleaning composition comprises, by weight of the composition, from about 2% to about 60% of the surfactant system. In further embodiments, the cleaning composition comprises, by weight of the composition, from about 5% to about 30% of the surfactant system. The surfactant system may comprise a detersive surfactant selected from anionic surfactants, non-ionic surfactants, cationic surfactants, zwitterionic surfactants, amphoteric surfactants, and mixtures thereof.

The selection of the additional surfactants and further ingredients in these embodiments may be dependent upon the application and the desired benefit.

All such cleaning compositions, their ingredients including (adjunct) cleaning additives, their gen-eral compositions and more specific compositions are known, as for example illustrated in the publications 800542 and 800500 as published by Protegas, Liechtenstein, and also from WO 2022/136409 and WO 2022/136408, wherein in any of the before prior art documents the polymers serving the same purpose as that of the present invention (i.e. especially the graft polymers made from PEG and vinyl esters and/or the dye transfer inhibiting polymers, more specifically dye transfer inhibiting polymers) within the general compositions and also each individualized specific cleaning composition disclosed in the beforementioned publications but also in any other publication disclosing cleaning formulations and products as contemplated herein may be replaced partially or completely by the inventive compound(s). Especially in those documents mentioned before in this paragraph, also various types of formulations for cleaning compositions are disclosed; all such composition types—the general compositions and also each individualized specific cleaning composition—can be equally applied also to those cleaning compositions con-templated herein.

Hence, the present invention also encompasses any and all of such disclosed compositions of the before-mentioned prior art-disclosures but further comprising at least one of the inventive compound in addition to or as a replacement for any already ins such prior art-composition contained the polymers serving the same purpose as that of the present invention or any such compound, which can be replaced by such inventive compound(s)—such replacements in principle known to a person of skill in the art or readily obvious in view of the present invention-, with the content of the inventive compound(s) being present in said formulations at a concentration as given in this chapter at the beginning, i.e. typically at a concentration of from about 0.1% to about 50%, preferably from about 0.25% to 15%, more preferably from about 0.5% to about 10%, and even more preferably from about 0.5% to about 5%, and most preferably in amounts of up to 3%, each in weight % in relation to the total weight of such composition/product.

### Laundry Compositions

“Laundry composition” may be any composition, formulation or product which is intended for use in launry including laundry care, laundry cleaning etc.; hence this term will be used in the following denoting any composition, formulation or product.

In laundry compositions, anionic surfactants contribute usually by far the largest share of surfactants within such formulation. Hence, preferably, the inventive cleaning compositions for use in laundry comprise at least one anionic surfactant and optionally further surfactants selected from any of the surfactant classes described herein, preferably from non-ionic surfactants and/or amphoteric surfactants and/or zwitterionic surfactants and/or cationic surfactants.

Cleaning compositions may—and preferably do—also contain anionic surfactants—which may be employed also in combinations of more than one other surfactant.

Nonlimiting examples of anionic surfactants—which may be employed also in combinations of more than one surfactant—useful herein include C9-C20 linear alkylbenzenesulfonates (LAS), C10-C20 primary, branched chain and random alkyl sulfates (AS); C10-C18 secondary (2,3) alkyl sulfates; C10-C18 alkyl alkoxy sulfates (AExS) wherein x is from 1 to 30; C10-C18 alkyl alkoxy carboxylates comprising 1 to 5 ethoxy units; mid-chain branched alkyl sulfates as discussed in U.S. Pat. Nos. 6,020,303 and 6,060,443; mid-chain branched alkyl alkoxy sulfates as discussed in U.S. Pat. Nos. 6,008,181 and 6,020,303; modified alkylbenzene sulfonate (MLAS) as discussed in WO 99/05243, WO 99/05242 and WO 99/05244; methyl ester sulfonate (MES); and alpha-olefin sulfonate (AOS).

Preferred examples of suitable anionic surfactants are alkali metal and ammonium salts of C8-C12-alkyl sulfates, of C12-C18-fatty alcohol ether sulfates, of C12-C18-fatty alcohol polyether sulfates, of sulfuric acid half-esters of ethoxylated C4-C12-alkylphenols (ethoxylation: 3 to 50 mol of ethylene oxide/mol), of C12-C18-alkylsulfonic acids, of C12-C18 sulfo fatty acid alkyl esters, for example of C12-C18 sulfo fatty acid methyl esters, of C10-C18-alkylarylsulfonic acids, preferably of n-C10-C18-alkylbenzene sulfonic acids, of C10-C18 alkyl alkoxy carboxylates and of soaps such as for example C8-C24-carboxylic acids. Preference is given to the alkali metal salts of the aforementioned compounds, particularly preferably the sodium salts.

In one embodiment of the present invention, anionic surfactants are selected from n-C10-C18-alkylbenzene sulfonic acids and from fatty alcohol polyether sulfates, which, within the context of the present invention, are in particular sulfuric acid half-esters of ethoxylated C12-C18-alkanols (ethoxylation: 1 to 50 mol of ethylene oxide/mol), preferably of n-C12-C18-alkanols.

In one embodiment of the present invention, also alcohol polyether sulfates derived from branched (i.e., synthetic) C11-C18-alkanols (ethoxylation: 1 to 50 mol of ethylene oxide/mol) may be employed. Preferably, the alkoxylation group of both types of alkoxylated alkyl sulfates, based on C12-C18-fatty alcohols or based on branched (i.e., synthetic) C11-C18-alcohols, is an ethoxylation group and an average ethoxylation degree of any of the alkoxylated alkyl sulfates is 1 to 5, preferably 1 to 3.

Preferably, the laundry detergent formulation of the present invention comprises from at least 1 wt.-% to 50 wt.-%, preferably in the range from greater than or equal to about 2 wt.-% to equal to or less than about 30 wt.-%, more preferably in the range from greater than or equal to 3 wt.-% to less than or equal to 25 wt.-%, and most preferably in the range from greater than or equal to 5 wt.-% to less than or equal to 25 wt.-% of one or more anionic surfactants as described above, based on the particular overall composition, including other components and water and/or solvents.

In a preferred embodiment of the present invention, anionic surfactants are selected from C10-C15 linear alkylbenzenesulfonates, C10-C18 alkylethersulfates with 1-5 ethoxy units and C10-C18 alkylsulfates.

Cleaning compositions may also contain non-ionic surfactants-which may be employed also in combinations of more than one other surfactant.

Non-limiting examples of non-ionic surfactants-which may be employed also in combinations of more than one other surfactant-include: C8-C18 alkyl ethoxylates, such as, NEODOL® non-ionic surfactants from Shell; ethylenoxide/propylenoxide block alkoxylates as PLURONIC® from BASF; C14-C22 mid-chain branched alkyl alkoxylates, BAEx, wherein x is from 1 to 30, as discussed in U.S. Pat. Nos. 6,153,577, 6,020,303 and 6,093,856; alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; polyhydroxy fatty acid amides as discussed in U.S. Pat. No. 5,332,528; and ether capped poly (oxyalkylated) alcohol surfactants as discussed in U.S. Pat. No. 6,482,994 and WO 01/42408.

Preferred examples of non-ionic surfactants are in particular alkoxylated alcohols and alkoxylated fatty alcohols, di- and multiblock copolymers of ethylene oxide and propylene oxide and reaction products of sorbitan with ethylene oxide or propylene oxide, furthermore alkylphenol ethoxylates, alkyl glycosides, polyhydroxy fatty acid amides (glucamides). Examples of (additional) amphoteric surfactants are so-called amine oxides.

Preferred examples of alkoxylated alcohols and alkoxylated fatty alcohols are, for example, compounds of the general formula (A)

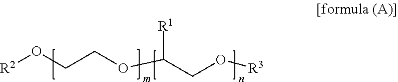

in which the variables are defined as follows:
R1 is selected from linear C1-C10-alkyl, preferably ethyl and particularly preferably methyl,
R2 is selected from C8-C22-alkyl, for example n-C8H17, n-C10H21, n-C12H25, n-C14H29, n-C16H33 or n-C18H37,
R3 is selected from C1-C10-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,
m and n are in the range from zero to 300, where the sum of n and m is at least one. Preferably, m is in the range from 1 to 100 and n is in the range from 0 to 30.

Here, compounds of the general formula (A) may be block copolymers or random copolymers, preference being given to block copolymers.

Other preferred examples of alkoxylated alcohols and alkoxylated fatty alcohols are, for example, compounds of the general formula (B)

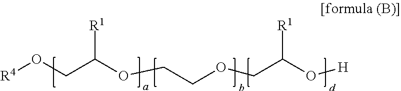

in which the variables are defined as follows:
R1 is identical or different and selected from linear C1-C4-alkyl, preferably identical in each case and ethyl and particularly preferably methyl,
R4 is selected from C6-C20-alkyl, in particular n-C8H17, n-C10H21, n-C12H25, n-C14H29, n-C16H33, n-C18H37,
a is a number in the range from zero to 6, preferably 1 to 6,
b is a number in the range from zero to 20, preferably 4 to 20,
d is a number in the range from 4 to 25.

Preferably, at least one of a and b is greater than zero.

Here, compounds of the general formula (B) may be block copolymers or random copolymers, preference being given to block copolymers.

Further suitable non-ionic surfactants are selected from di- and multiblock copolymers, composed of ethylene oxide and propylene oxide. Further suitable non-ionic surfactants are selected from ethoxylated or propoxylated sorbitan esters. Alkylphenol ethoxylates or alkyl polyglycosides or polyhydroxy fatty acid amides (glucamides) are likewise suitable. An overview of suitable further non-ionic surfactants can be found in EP-A 0 851 023 and in DE-A 198 19 187.

Mixtures of two or more different non-ionic surfactants may of course also be present.

In a preferred embodiment of the present invention, non-ionic surfactants are selected from C12/14 and C16/18 fatty alkoholalkoxylates, C13/15 oxoalkoholalkoxylates, C13-alkoholalkoxylates, and 2-propylheptylalkoholalkoxylates, each of them with 3-15 ethoxy units, preferably 5-10 ethoxy units, or with 1-3 propoxy- and 2-15 ethoxy units.

Cleaning compositions may also contain amphoteric surfactants—which may be employed also in combinations of more than one other surfactant.

Non-limiting examples of amphoteric surfactants-which may be employed also in combinations of more than one other surfactant-include: water-soluble amine oxides containing one alkyl moiety of from about 8 to about 18 carbon atoms and 2 moieties selected from the group consisting of alkyl moieties and hydroxyalkyl moieties containing from about 1 to about 3 carbon atoms; and water-soluble sulfoxides containing one alkyl moiety of from about 10 to about 18 carbon atoms and a moiety selected from the group consisting of alkyl moieties and hydroxyalkyl moieties of from about 1 to about 3 carbon atoms. See WO 01/32816, U.S. Pat. Nos. 4,681,704, and 4,133,779. Suitable surfactants include thus so-called amine oxides, such as lauryl dimethyl amine oxide (“lauramine oxide”).

Preferred examples of amphoteric surfactants are amine oxides. Preferred amine oxides are alkyl dimethyl amine oxides or alkyl amido propyl dimethyl amine oxides, more preferably alkyl dimethyl amine oxides and especially coco dimethyl amino oxides. Amine oxides may have a linear or mid-branched alkyl moiety. Typical linear amine oxides include water-soluble amine oxides containing one R1=C8-18 alkyl moiety and two R2 and R3 moieties selected from the group consisting of C1-C3 alkyl groups and C1-C3 hydroxyalkyl groups. Preferably, the amine oxide is characterized by the formula

R1-N(R2)(R3)-O
wherein R¹ is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the alpha carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that (n1-n2) is less than or equal to 5, preferably 4, most preferably from 0 to 4 carbon atoms in at least 50 wt.-%, more preferably at least 75 wt.-% to 100 wt.-% of the mid-branched amine oxides for use herein. The amine oxide further comprises two moieties, independently selected from a C1-C3 alkyl, a C1-C3 hydroxyalkyl group, or a polyethylene oxide group containing an average of from about 1 to about 3 ethylene oxide groups. Preferably the two moieties are selected from a C1-C3 alkyl, more preferably both are selected as a C1 alkyl.

In a preferred embodiment of the present invention, amphoteric surfactants are selected from C8-C18 alkyl-dimethyl aminoxides and C8-C18 alkyl-di (hydroxyethyl) aminoxide.

Cleaning compositions may also contain zwitterionic surfactants-which may be employed also in combinations of more than one other surfactant.

Suitable zwitterionic surfactants include betaines, such as alkyl betaines, alkylamidobetaine, amidazoliniumbetaine, sulfobetaine (INCI Sultaines) as well as the phosphobetaines. Examples of suitable betaines and sulfobetaines are the following (designated in accordance with INCI): Almond amidopropyl of betaines, Apricotamidopropyl betaines, Avocadamidopropyl of betaines, Babassuamidopropyl of betaines, Behenamidopropyl betaines, Behenyl of betaines, Canol amidopropyl betaines, Capryl/Capramidopropyl betaines, Carnitine, Cetyl of betaines, Cocamidoethyl of betaines, Cocamidopropyl betaines, Cocamidopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucamidopropyl Hydroxysultaine, Hydrogenated Tallow of betaines, Isostearamidopropyl betaines, Lauramidopropyl betaines, Lauryl of betaines, Lauryl Hydroxysultaine, Lauryl Sultaine, Milkamidopropyl betaines, Minkamidopropyl of betaines, Myristamidopropyl betaines, Myristyl of betaines, Oleamidopropyl betaines, Oleamidopropyl Hydroxysultaine, Oleyl of betaines, Olivamidopropyl of betaines, Palmamidopropyl betaines, Palmitamidopropyl betaines, Palmitoyl Carnitine, Palm Kernelamidopropyl betaines, Polytetrafluoroethylene Acetoxypropyl of betaines, Ricinoleam idopropyl betaines, Sesamidopropyl betaines, Soyamidopropyl betaines, Stearamidopropyl betaines, Stearyl of betaines, Tallowamidopropyl betaines, Tallowamidopropyl Hydroxysultaine, Tallow of betaines, Tallow Dihydroxyethyl of betaines, Undecylenamidopropyl betaines and Wheat Germamidopropyl betaines.

Preferred betaines are, for example, C12-C18-alkylbetaines and sulfobetaines. The zwitterionic surfactant preferably is a betaine surfactant, more preferable a Cocoamidopropylbetaine surfactant. Non-limiting examples of cationic surfactants-which may be employed also in combinations of more than one other surfactant-include: the quaternary ammonium surfactants, which can have up to 26 carbon atoms include: alkoxylated quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

Compositions according to the invention may comprise at least one builder. In the context of the present invention, no distinction will be made between builders and such components elsewhere called “co-builders”. Examples of builders are complexing agents, hereinafter also referred to as complexing agents, ion exchange compounds, and precipitating agents. Builders are selected from citrate, phosphates, silicates, carbonates, phosphonates, amino carboxylates and polycarboxylates.

In the context of the present invention, the term citrate includes the mono- and the dialkali metal salts and in particular the mono- and preferably the trisodium salt of citric acid, ammonium or substituted ammonium salts of citric acid as well as citric acid. Citrate can be used as the anhydrous compound or as the hydrate, for example as sodium citrate dihydrate. Quantities of citrate are calculated referring to anhydrous trisodium citrate.

The term phosphate includes sodium metaphosphate, sodium orthophosphate, sodium hydrogenphosphate, sodium pyrophosphate and polyphosphates such as sodium tripolyphosphate. Preferably, however, the composition according to the invention is free from phosphates and polyphosphates, with hydrogenphosphates being subsumed, for example free from trisodium phosphate, pentasodium tripolyphosphate and hexasodium metaphosphate (“phosphate-free”). In connection with phosphates and polyphosphates, “free from” should be understood within the context of the present invention as meaning that the content of phosphate and polyphosphate is in total in the range from 10 ppm to 0.2% by weight of the respective composition, determined by gravimetry. The term carbonates includes alkali metal carbonates and alkali metal hydrogen carbonates, preferred are the sodium salts. Particularly preferred is Na2CO3.

Examples of phosphonates are hydroxyalkanephosphonates and aminoalkanephosphonates. Among the hydroxyalkanephosphonates, the 1-hydroxyethane-1,1-diphosphonate (HEDP) is of particular importance as builder. It is preferably used as sodium salt, the disodium salt being neutral and the tetrasodium salt being alkaline (pH 9). Suitable aminoalkanephosphonates are preferably ethylene diaminetetramethylenephosphonate (EDTMP), diethylenetriaminepentamethylenephosphonate (DTPMP), and also their higher homologues. They are preferably used in the form of the neutrally reacting sodium salts, e.g. as hexasodium salt of EDTMP or as hepta- and octa-sodium salts of DTPMP.

Examples of amino carboxylates and polycarboxylates are nitrilotriacetates, ethylene diamine tetraacetate, diethylene triamine pentaacetate, triethylene tetraamine hexaacetate, propylene diamines tetraacetic acid, ethanol-diglycines, methylglycine diacetate, and glutamine diacetate. The term amino carboxylates and polycarboxylates also include their respective non-substituted or substituted ammonium salts and the alkali metal salts such as the sodium salts, in particular of the respective fully neutralized compound.

Silicates in the context of the present invention include in particular sodium disilicate and sodium metasilicate, alumosilicates such as for example zeolites and sheet silicates, in particular those of the formula α-Na2Si2O5, β-Na2Si2O5, and δ-Na2Si2O5.

Compositions according to the invention may contain one or more builder selected from materials not being mentioned above. Examples of builders are α-hydroxypropionic acid and oxidized starch.

In one embodiment of the present invention, builder is selected from polycarboxylates. The term “polycarboxylates” includes non-polymeric polycarboxylates such as succinic acid, C2-C16-alkyl disuccinates, C2-C16-alkenyl disuccinates, ethylene diamine N,N′-disuccinic acid, tartaric acid diacetate, alkali metal malonates, tartaric acid monoacetate, propanetricarboxylic acid, butanetetracarboxylic acid and cyclopentanetetracarboxylic acid.

Oligomeric or polymeric polycarboxylates are for example polyaspartic acid or in particular alkali metal salts of (meth)acrylic acid homopolymers or (meth)acrylic acid copolymers.

Suitable co-monomers are monoethylenically unsaturated dicarboxylic acids such as maleic acid, fumaric acid, maleic anhydride, itaconic acid and citraconic acid. A suitable polymer is in particular polyacrylic acid, which preferably has a weight-average molecular weight Mw in the range from 2000 to 40 000 g/mol, preferably 2000 to 10 000 g/mol, in particular 3000 to 8000 g/mol. Further suitable copolymeric polycarboxylates are in particular those of acrylic acid with methacrylic acid and of acrylic acid or methacrylic acid with maleic acid and/or fumaric acid.

It is also possible to use copolymers of at least one monomer from the group consisting of monoethylenically unsaturated C3-C10-mono- or C4-C10-dicarboxylic acids or anhydrides thereof, such as maleic acid, maleic anhydride, acrylic acid, methacrylic acid, fumaric acid, itaconic acid and citraconic acid, with at least one hydrophilically or hydrophobically modified co-monomer as listed below.

Suitable hydrophobic co-monomers are, for example, isobutene, diisobutene, butene, pentene, hexene and styrene, olefins with ten or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C22-α-olefin, a mixture of C20-C24-α-olefins and polyisobutene having on average 12 to 100 carbon atoms per molecule.

Suitable hydrophilic co-monomers are monomers with sulfonate or phosphonate groups, and also non-ionic monomers with hydroxyl function or alkylene oxide groups. By way of example, mention may be made of: allyl alcohol, isoprenol, methoxypolyethylene glycol (meth) acrylate, methoxypolypropylene glycol (meth) acrylate, methoxypolybutylene glycol (meth) acrylate, methoxypoly (propylene oxide-co-ethylene oxide) (meth) acrylate, ethoxypolyethylene glycol (meth) acrylate, ethoxypolypropylene glycol (meth) acrylate, ethoxypolybutylene glycol (meth) acrylate and ethoxypoly (propylene oxide-co-ethylene oxide) (meth) acrylate. Polyalkylene glycols here can comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts. Moreover, amphoteric polymers can also be used as builders.

Compositions according to the invention can comprise, for example, in the range from in total 0.1 to 70% by weight, preferably 10 to 50% by weight, preferably up to 20% by weight, of builder(s), especially in the case of solid formulations. Liquid formulations according to the invention preferably comprise in the range of from 0.1 to 8% by weight of builder.

Formulations according to the invention can comprise one or more alkali carriers. Alkali carriers ensure, for example, a pH of at least 9 if an alkaline pH is desired. Of suitability are, for example, the alkali metal carbonates, the alkali metal hydrogen carbonates, and alkali metal metasilicates mentioned above, and, additionally, alkali metal hydroxides. A preferred alkali metal is in each case potassium, particular preference being given to sodium. In one embodiment of the present invention, a pH>7 is adjusted by using amines, preferably alkanolamines, more preferably triethanolamine.

In one embodiment of the present invention, the laundry formulation or composition according to the invention comprises additionally at least one enzyme.

Useful enzymes are, for example, one or more hydrolases selected from lipases, amylases, proteases, cellulases, hemicellulases, phospholipases, esterases, pectinases, lactases and peroxidases, and combinations of at least two of the foregoing types.

In one embodiment, the composition according to the present invention comprises additionally at least one enzyme.

Preferably, the at least one enzyme is a detergent enzyme.

In one embodiment, the enzyme is classified as an oxidoreductase (EC 1), a transferase (EC 2), a hydrolase (EC 3), a lyase (EC 4), an isomerase (EC 5), or a ligase (EC 6) (the EC-numbering is according to Enzyme Nomenclature, Recommendations (1992) of the Nomenclature Committee of the International Union of Biochemistry and Molecular Biology including its supplements published 1993-1999). Preferably, the enzyme is a hydrolase (EC 3).

In a preferred embodiment, the enzyme is selected from the group consisting of proteases, amylases, lipases, cellulases, mannanases, hemicellulases, phospholipases, esterases, pectinases, lactases, peroxidases, xylanases, cutinases, pectate lyases, keratinases, reductases, oxidases, phenoloxidases, lipoxygenases, ligninases, pullulanases, tannases, pentosanases, malanases, beta-glucanases, arabinosidases, hyaluronidases, chondroitinases, laccases, nucleases, DNase, phosphodiesterases, phytases, carbohydrases, galactanases, xanthanases, xyloglucanases, oxidoreductase, perhydrolases, aminopeptidase, asparaginase, carbohydrase, carboxypeptidase, catalase, chitinase, cyclodextrin glycosyltransferase, alpha-galactosidase, beta-galactosidase, glucoamylase, alpha-glucosidase, beta-glucosidase, invertase, ribonuclease, transglutaminase, and dispersins, and combinations of at least two of the foregoing types. More preferably, the enzyme is selected from the group consisting of proteases, amylases, lipases, cellulases, mannanases, xylanases, DNases, dispersins, pectinases, oxidoreductases, and cutinases, and combinations of at least two of the foregoing types. Most preferably, the enzyme is a protease, preferably, a serine protease, more preferably, a subtilisin protease.

Such enzyme(s) can be incorporated into the composition at levels sufficient to provide an effective amount for achieving a beneficial effect, preferably for primary washing effects and/or secondary washing effects, like antigreying or antipilling effects (e.g., in case of cellulases). Preferably, the enzyme is present in the composition at levels from about 0.00001% to about 5%, preferably from about 0.00001% to about 2%, more preferably from about 0.0001% to about 1%, or even more preferably from about 0.001% to about 0.5% enzyme protein by weight of the composition. Preferably, the enzyme-containing composition further comprises an enzyme stabilizing system. Preferably, the enzyme-containing composition described herein comprises from about 0.001% to about 10%, from about 0.005% to about 8%, or from about 0.01% to about 6%, by weight of the composition, of an enzyme stabilizing system. The enzyme stabilizing system can be any stabilizing system which is compatible with the enzyme.

Preferably, the enzyme stabilizing system comprises at least one compound selected from the group consisting of polyols (preferably, 1,3-propanediol, ethylene glycol, glycerol, 1,2-propanediol, or sorbitol), salts (preferably, CaCl2, MgCl2, or NaCl), short chain (preferably, C1-C6) carboxylic acids (preferably, formic acid, formate (preferably, sodium formate), acetic acid, acetate, or lactate), borate, boric acid, boronic acids (preferably, 4-formyl phenylboronic acid (4-FPBA)), peptide aldehydes, peptide acetals, and peptide aldehyde hydrosulfite adducts. Preferably, the enzyme stabilizing system comprises a combination of at least two of the compounds selected from the group consisting of salts, polyols, and short chain carboxylic acids and preferably one or more of the compounds selected from the group consisting of borate, boric acid, boronic acids (preferably, 4-formyl phenylboronic acid (4-FPBA)), peptide aldehydes, peptide acetals, and peptide aldehyde hydrosulfite adducts. In particular, if proteases are present in the composition, protease inhibitors may be added, preferably selected from borate, boric acid, boronic acids (preferably, 4-FPBA), peptide aldehydes (preferably, peptide aldehydes like Z-VAL-H or Z-GAY-H), peptide acetals, and peptide aldehyde hydrosulfite adducts. Compositions according to the invention may comprise one or more bleaching agent (bleaches). Preferred bleaches are selected from sodium perborate, anhydrous or, for example, as the monohydrate or as the tetrahydrate or so-called dihydrate, sodium percarbonate, anhydrous or, for example, as the monohydrate, and sodium persulfate, where the term “persulfate” in each case includes the salt of the peracid H2SO5 and also the peroxodisulfate.

In this connection, the alkali metal salts can in each case also be alkali metal hydrogen carbonate, alkali metal hydrogen perborate and alkali metal hydrogen persulfate. However, the dialkali metal salts are preferred in each case.

Formulations according to the invention can comprise one or more bleach catalysts. Bleach catalysts can be selected from oxaziridinium-based bleach catalysts, bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Formulations according to the invention can comprise one or more bleach activators, for example tetraacetyl ethylene diamine, tetraacetylmethylene diamine, tetraacetylglycoluril, tetraacetylhexylene diamine, acylated phenolsulfonates such as for example n-nonanoyl- or isononanoyloxybenzene sulfonates, N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Formulations according to the invention can comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol. In one embodiment of the present invention, formulations according to the invention comprise in total in the range from 0.1 to 1.5% by weight of corrosion inhibitor.

Formulations according to the invention may also comprise further cleaning polymers and/or soil release polymers.

The additional cleaning polymers may include, without limitation, “multifunctional polyethylene imines” (for example BASF's Sokalan® HP20) and/or “multifunctional diamines” (for example BASF's Sokalan® HP96). Such multifunctional polyethylene imines are typically ethoxylated polyethylene imines with a weight-average molecular weight Mw in the range from 3000 to 250000, preferably 5000 to 200000, more preferably 8000 to 100000, more preferably 8000 to 50000, more preferably 10000 to 30000, and most preferably 10000 to 20000 g/mol. Suitable multifunctional polyethylene imines have 80 wt.-% to 99 wt.-%, preferably 85 wt.-% to 99 wt.-%, more preferably 90 wt.-% to 98 wt.-%, most preferably 93 wt.-% to 97 wt.-% or 94 wt.-% to 96 wt.-% ethylene oxide side chains, based on the total weight of the materials. Ethoxylated polyethylene imines are typically based on a polyethylene imine core and a polyethylene oxide shell. Suitable polyethylene imine core molecules are polyethylene imines with a weight-average molecular weight Mw in the range of 500 to 5000 g/mol. Preferably employed is a molecular weight from 500 to 1000 g/mol, even more preferred is a Mw of 600 to 800 g/mol. The ethoxylated polymer then has on average 5 to 50, preferably 10 to 35 and even more preferably 20 to 35 ethylene oxide (EO) units per NH-functional group.

Suitable multifunctional diamines are typically ethoxylated C2 to C12 alkylene diamines, preferably hexamethylene diamine, which are further quaternized and optionally sulfated. Typical multifunctional diamines have a weight-average molecular weight Mw in the range from 2000 to 10000, more preferably 3000 to 8000, and most preferably 4000 to 6000 g/mol. In a preferred embodiment of the invention, ethoxylated hexamethylene diamine, furthermore quaternized and sulfated, may be employed, which contains on average 10 to 50, preferably 15 to 40 and even more preferably 20 to 30 ethylene oxide (EO) groups per NH-functional group, and which preferably bears two cationic ammonium groups and two anionic sulfate groups.

In a preferred embodiment of the present invention, the cleaning compositions may contain at least one multifunctional polyethylene imine and/or at least one multifunctional diamine to improve the cleaning performance, such as preferably improve the stain removal ability, especially the primary detergency of particulate stains on polyester fabrics of laundry detergents. The multifunctional polyethylene imines or multifunctional diamines or mixtures thereof according to the descriptions above may be added to the laundry detergents and cleaning compositions in amounts of generally from 0.05 to 15 wt.-%, preferably from 0.1 to 10 wt.-% and more preferably from 0.25 to 5 wt.-% and even as low as up to 2 wt. %, based on the particular overall composition, including other components and water and/or solvents.

Thus, one aspect of the present invention is a laundry detergent composition, in particular a liquid laundry detergent, comprising (i) at least one inventive polymer and (ii) at least one compound selected from multifunctional polyethylene imines and multifunctional diamines and mixtures thereof. In one embodiment of the present invention, the ratio of the at least one inventive polymer and (ii) the at least one compound selected from multifunctional polyethylene imines and multifunctional diamines and mixtures thereof, is from 10:1 to 1:10, preferably from 5:1 to 1:5 and more preferably from 3:1 to 1:3.

Cleaning compositions, fabric and home care products and specifically the laundry formulations comprising the inventive polymer may also comprise at least one antimicrobial agent (named also “preservative”).

An antimicrobial agent is a chemical compound that kills microorganisms or inhibits their growth or reproduction. Microorganisms can be bacteria, yeasts or molds. A preservative is an antimicrobial agent which may be added to aqueous products and compositions to maintain the original performance, characteristics and integrity of the products and compositions by killing contaminating microorganisms or inhibiting their growth.

The composition/formulation may contain one or more antimicrobial agents and/or preservatives as listed in patent WO2021/115912 A1 (“Formulations comprising a hydrophobically modified polyethyleneimine and one or more enzymes”) on pages 35 to 39.

Especially of interest for the cleaning compositions and fabric and home care products and specifically in the laundry formulations are any of the following antimicrobial agents and/or preservatives:
4,4′-dichloro 2-hydroxydiphenyl ether (further names: 5-chloro-2-(4-chlorophenoxy) phenol, Diclosan,
DCPP), Tinosan® HP 100 (commercial product of BASF SE containing 30% of the antimicrobial active 4,4′-dichoro 2-hydroxydiphenylether); 2-Phenoxyethanol (further names: Phenoxyethanol, Methylphenylglycol, Phenoxetyethanol, ethylene glycol phenyl ether, Ethylene glycol monophenyl ether, 2-(phenoxy) ethanol, 2-phenoxy-1-ethanol); 2-bromo-2-nitropropane-1,3-diol (further names: 2-bromo-2-nitro-1,3-propanediol, Bronopol); Glutaraldehyde (further names: 1-5-pentandial, pentane-1,5-dial, glutaral, glutar-dialdehyde); Glyoxal (further names: ethandial, oxylaldehyde, 1,2-ethandial); 2-butyl-benzo[d]isothiazol-3-one (“BBIT”); 2-methyl-2H-isothiazol-3-one (“MIT”); 2-octyl-2H-isothiazol-3-one (“OIT”); 5-Chloro-2-methyl-2H-isothiazol-3-one (“CIT” or “CMIT”); Mixture of 5-chloro-2-methyl-2H-isothiazol-3-one (“CMIT”) and 2-methyl-2H-isothiazol-3-one (“MIT”) (Mixture of CMIT/MIT); 1,2-benzisothiazol-3 (2H)-one (“BIT”); Hexa-2,4-dienoic acid (trivial name “sorbic acid”) and its salts, e.g., calcium sorb-ate, sodium sorbate; potassium (E,E)-hexa-2,4-dienoate (Potassium Sorbate); Lactic acid and its salts; L-(+)-lactic acid; especially sodium lactate; Benzoic acid and salts of benzoic acid, e.g., sodium benzoate, ammonium benzo-ate, calcium benzoate, magnesium benzoate, MEA-benzoate, potassium benzoate; Salicylic acid and its salts, e.g., calcium salicylate, magnesium salicylate, MEA salicylate, sodium salicylate, potassium salicylate, TEA salicylate; bromide, Benzalkonium chloride, benzalkonium benzalkonium saccharinate; Didecyldimethylammonium chloride (“DDAC”); N-(3-aminopropyl)-N-dodecylpropane-1,3-diamine (“Diamine”); Peracetic acid; Hydrogen peroxide.

At least one antimicrobial agent or preservative may be added to the inventive composition in a concentration of 0.001 to 10% relative to the total weight of the composition.

Preferably, the composition contains 2-phenoxyethanol in a concentration of 0.1 to 2% or 4,4′-dichloro 2-hydroxydiphenyl ether (DCPP) in a concentration of 0.005 to 0.6%.

The invention also encompasses a method of preserving an aqueous compo-sition according to the invention against microbial contamination or growth, which method comprises addition of at least one antimicrobial agent or preservative, preferably 2-phenoxyethanol.

The invention also encompasses a method of providing an antimicrobial effect on textiles after treatment with a solid laundry detergent (e.g. powders, granu-lates, capsules, tablets, bars etc.), a liquid laundry detergent, a softener or an af-ter-rinse containing 4,4′-dichloro 2-hydroxydiphenyl ether (DCPP).

Formulations according to the invention may also comprise water and/or additional organic solvents, e.g., ethanol or propylene glycol.

Further optional ingredients may be but are not limited to viscosity modifiers, cationic surfactants, foam boosting or foam reducing agents, perfumes, dyes, optical brighteners, and dye transfer inhibiting agents.

### General Cleaning Compositions and Formulations for Laundry

The disclosed liquid formulations in this chapter may and preferably do comprise 0 to 2% 2-phenoxyethanol, preferably about 1%, in addition to all other mentioned ingredients.

The above and below disclosed liquid formulations may and preferably do comprise 0-0.2% 4,4′-dichoro 2-hydroxydiphenylether, preferably about 0.15%, in addition to all other mentioned ingredients. The bleach-free solid laundry compositions may comprise 0-0.2% 4,4′-dichoro 2-hydroxydiphenylethe, preferably about 0.15%, in addition to all other mentioned ingredients.

The disclosed formulations in this chapter may and preferably do comprise one or more enzymes selected from those disclosed herein above, more preferably a protease and/or an amylase, wherein even more preferably the protease is a protease with at least 90% sequence identity to SEQ ID NO: 22 of EP1921147B1 and having the amino acid substitution R101E (according to BPN′ numbering) and wherein the amylase is an amylase with at least 90% sequence identity to SEQ ID NO: 54 of WO2021032881A1, such enzyme(s) preferably being present in the formulations at levels from about 0.00001% to about 5%, preferably from about 0.00001% to about 2%, more preferably from about 0.0001% to about 1%, or even more preferably from about 0.001% to about 0.5% enzyme protein by weight of the composition.

The tables in this chapter show general cleaning compositions of certain types, which correspond to typical compositions correlating with typical washing conditions as typically employed in various regions and countries of the world. The at least one inventive polymer may be added to such formulation(s) in suitable amounts as outlined herein.

When no inventive polymer is added, a shown formulation is a “comparative formulation”; when the amount chosen is in the general range as disclosed herein andspecifically within ranges disclosed herein as preferred amounts for the various ingredients and the graft polymer of the invention, the formulation is a formulation according to the invention. Ingredients (other than the inventive polymer) listed with amounts including “zero %” in the mentioned range may be present but not necessarily have to be present, in both the inventive and the comparative formulations. Hence, each number encompassed by a given range is meant to be included in the formulations shown in this chapter, and all variationsand permutations possible are likewise meant to be included.

In a preferred embodiment the graft polymer according to the present invention is used in a laundry detergent.

Liquid laundry detergents according to the present invention are composed of:
0.05-10% of at least one inventive polymer
1-50% of surfactants
0.1-40% of builders, cobuilders and/or chelating agents
0.1-50% other adjuncts
water to add up 100%.

Preferred liquid laundry detergents according to the present invention are composed of:
0.2-4% of at least one inventive polymer
5-40% of anionic surfactants selected from C10-C15-LAS and C10-C18 alkyl ethersulfates containing 1-5 ethoxy-units
1.5-10% of nonioic surfactants selected from C10-C18-alkyl ethoxylates containing 3-10 ethoxy-units
2-20% of soluble organic builders/cobuilders selected from C10-C18 fatty acids, di- and tricarboxylic acids, hydroxy-di- and hydroxytricaboxylic acids, aminopolycarboxylates and polycarboxylic acids
0.05-5% of an enzyme system containing at least one enzyme suitable for detergent use and preferably also an enzyme stabilizing system
0.5-20% of mono- or diols selected from ethanol, isopropanol, ethylenglycol, or propylenglyclol
0.1-20% other adjuncts
water to add up to 100%.

Solid laundry detergents (like e.g. powders, granules or tablets) according to the present invention are composed of:
0.05-10% of at least one inventive polymer
1-50% of surfactants
0.1-90% of builders, cobuilders and/or chelating agents
0-50% of fillers
0-40% of bleach actives
0.1-30% of other adjuncts and/or water
wherein the sum of the ingredients adds up 100%.

Preferred solid laundry detergents according to the present invention are composed of:
0.2-2% of at least one inventive polymer
5-30% of anionic surfactants selected from C10-C15-LAS, C10-C18 alkylsulfates and C10-C18 alkyl ethersulfates containing 1-5 ethoxy-units
1.5-7.5% of non-ionic surfactants selected from C10-C18-alkyl ethoxylates containing 3-10 ethoxy-units
20-80% of inorganic builders and fillers selected from sodium carbonate, sodium bicarbonate, zeolites, soluble silicates, sodium sulfate
0.5-15% of cobuilders selected from C10-C18 fatty acids, di- and tricarboxylic acids, hydroxydi- and hydroxytricarboxylic acids, aminopolycarboxylates and polycarboxylic acids
0.1-5% of an enzyme system containing at least one enzyme suitable for detergent use and preferably also an enzyme stabilizing system
0.5-30% of bleach actives
0.1-20% other adjuncts
water to ad up to 100%

General formula for laundry detergent compositions
according to the invention:

| | Ranges of Ingredient |
|---|---|
| | in Liquid frame |
| Ingredient | formulations |
| Linear alkyl benzene | 0 to 30% |
| sulphonic acid | |
| Coco fatty acid | 1 to 12% |
| Fatty alcohol ether sulphate | 0 to 25% |
| NaOH or mono or triethanol amine | Up to pH 7.5 to 9.0 |
| Alcohol ethoxylate | 3 to 10% |
| 1,2-Propylene glycol | 1 to 10% |
| Ethanol | 0 to 4% |
| Sodium citrate | 0 to 8% |
| water | Up to 100% |

Liquid laundry frame formulations according to the invention:

| | (numbers: % active) | | | | | |
|---|---|---|---|---|---|---|
| active | F1 | F2 | F3 | F4 | F5 | F6 |
| alcohol ethoxylat 7EO | 5.40 | 10.80 | 12.40 | 7.30 | 1.60 | 7.60 |
| Coco fatty acid K12-18 | 2.40 | 3.10 | 3.20 | 3.20 | 3.50 | 6.40 |
| Fatty alcohol ether | 5.40 | 8.80 | 7.10 | 7.10 | 5.40 | 14.00 |
| sulphate | | | | | | |
| Linear alkyl benzene | 5.50 | 0.00 | 14.50 | 15.50 | 10.70 | 0.00 |
| sulphonic acid | | | | | | |
| 1,2 Propandiol | 6.00 | 3.50 | 8.70 | 8.70 | 1.10 | 7.80 |
| Triethanolamine | 0 | 0 | 0 | 0 | 0 | 0 |
| Monoethanolamine | 0 | 0 | 4.00 | 4.30 | 0.30 | 0 |
| NaOH | 2.20 | 1.10 | 0 | 0 | 0 | 1.00 |
| Glycerol | 0 | 0.80 | 3.00 | 2.80 | 0 | 0 |
| Ethanol | 2.00 | 0 | 0 | 0 | 0.38 | 0.39 |
| Na citrate | 3.00 | 2.80 | 3.40 | 2.10 | 7.40 | 5.40 |
| Inventive Polymer (s) | 0.2-4 | 0.2-4 | 0.2-4 | 0.2-4 | 0.2-4 | 0.2-4 |
| (total) | | | | | | |
| Other polymers | 0-6 | 0-6 | 0-6 | 0-6 | 0-6 | 0-6 |
| Protease | 0-1 | 0-1 | 0-1 | 0-1 | 0-1 | 0-1 |
| Amylase | 0-0.5 | 0-0.5 | 0-0.5 | 0-0.5 | 0-0.5 | 0-0.5 |
| Cellulase | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 |
| water | to 100 | to 100 | to 100 | to 100 | to 100 | to 100 |

Liquid laundry frame formulations according to the invention - continued:

| | (numbers: % active) | | | | | | | |
|---|---|---|---|---|---|---|---|---|
| active | F7 | F8 | F9 | F10 | F11 | F12 | F13 | F14 |
| alcohol ethoxylat 7EO | 3.80 | 0.30 | 13.30 | 8.00 | 5.70 | 20.00 | 9.20 | 29.00 |
| Coco fatty acid K12- | 2.80 | 3.00 | 1.70 | 1.80 | 2.50 | 5.00 | 8.60 | 10.40 |
| 18 | | | | | | | | |
| Fatty alcohol ether | 2.80 | 4.50 | 3.90 | 4.10 | 0 | 10.00 | 22.20 | 0 |
| sulphate | | | | | | | | |
| Linear alkyl benzene | 6.30 | 5.43 | 11.45 | 5.90 | 10.10 | 10.00 | 28.00 | 27.00 |
| sulphonic acid | | | | | | | | |
| 1,2 Propandiol | 0.50 | 0 | 2.50 | 0.40 | 6.00 | 10.00 | 7.00 | 7.00 |
| Triethanolamine | 0 | 0 | 0 | 8.10 | 0 | 0 | 0 | 0 |
| Monoethanolamine | 0.40 | 1.80 | 0 | 0 | 0 | 0 | 8.00 | 7.00 |
| NaOH | 0 | 0 | 2.20 | 0 | 3.30 | 1.50 | 0 | 0 |
| Glycerol | 0 | 0.60 | 0.20 | 1.90 | 0 | 0 | 7.00 | 10.00 |
| Ethanol | 0 | 0 | 1.84 | 0 | 0 | 0 | 0 | 0 |
| Na citrate | 4.60 | 3.30 | 3.30 | 1.40 | 0 | 1.50 | 0 | 0 |
| Inventive Polymer | 0.2-4 | 0.2-4 | 0.2-4 | 0.2-4 | 0.2-4 | 0.2-4 | 0.2-4 | 0.2-4 |
| (s) (total) | | | | | | | | |
| Other polymers | 0-6 | 0-6 | 0-6 | 0-6 | 0-6 | 0-6 | 0-6 | 0-6 |
| Protease | 0-1 | 0-1 | 0-1 | 0-1 | 0-1 | 0-3 | 0-3 | 0-3 |
| Amylase | 0-0.5 | 0-0.5 | 0-0.5 | 0-0.5 | 0-0.5 | 0-0.5 | 0-0.5 | 0-0.5 |
| Cellulase | 0-0.3 | 0-0.3 | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 | 0-0.3 | 0-0.3 |
| water | to 100 | to 100 | to 100 | to 100 | to 100 | to 100 | to 100 | to 100 |

Laundry powder frame formulations according to the invention:

| | Bleach free Powder | | | | | |
|---|---|---|---|---|---|---|
| Alcohol ethoxylate 7EO | 0.6 | 0 | 1 | 0 | 0 | 5.2 |
| Coco fatty acid K12-18 | 1.2 | 0 | 0 | 0 | 0 | 0 |
| Fatty alcohol ether | 1.5 | 0 | 0 | 0 | 0 | 6 |
| sulphate | | | | | | |
| Linear alkyl benzene | 12.1 | 11.2 | 13.6 | 21.9 | 18.7 | 12.7 |
| sulphonic acid | | | | | | |
| Bleach activator | 0 | 0 | 0 | 0 | 0 | 0 |
| Percarbonate | 0 | 0 | 0 | 0 | 0 | 0 |
| AcetateNa | 0 | 0 | 0 | 0.1 | 0 | 0.1 |
| CitrateNa | 0 | 0 | 0 | 0 | 0 | 14 |
| Na Silicate | 27.9 | 5.8 | 6.6 | 2 | 15 | 20.3 |
| Na Carbonate | 17.2 | 35 | 37.3 | 30.1 | 37 | 1 |
| Na Phosphate | 0 | 0 | 0 | 14 | 0.3 | 0 |
| Na Hydrogencarbonate | 0.7 | 0.9 | 0.5 | 2.7 | 0.4 | 10.5 |
| Zeolite4A | 4.2 | 0.1 | 5.1 | 10.2 | 1.8 | 11.6 |
| HEDP | 0 | 0 | 0 | 0 | 0 | 0.13 |
| MGDA | 0 | 1.1 | 0 | 0 | 0 | 0 |
| Cellulase | 0-0.5 | 0-0.5 | 0-0.5 | 0-0.5 | 0-0.5 | 0-0.5 |
| Lipase | 0-0.4 | 0-0.4 | 0-0.4 | 0-0.4 | 0-0.4 | 0-0.4 |
| Mannanase | 0-0.4 | 0-0.4 | 0-0.4 | 0-0.4 | 0-0.4 | 0-0.4 |
| Protease | 0-1.5 | 0-1.5 | 0-1.5 | 0-1.5 | 0-1.5 | 0-1.5 |
| Amylase | 0-0.5 | 0-0.5 | 0-0.5 | 0-0.5 | 0-0.5 | 0-0.5 |
| Na Sulfate | 30.8 | 1.3 | 33 | 11 | 22 | 3 |
| Na Chloride | 0.2 | 43 | 0.1 | 0 | 0.1 | 0.1 |
| optical brightener | 0.02 | 0 | | 0.1 | 0.06 | |
| Inventive Polymer(s) | 0.2-4 | 0.2-4 | 0.2-4 | 0.2-4 | 0.2-4 | 0.2-4 |
| (total) | | | | | | |
| Other polymers | 0-6 | 0-6 | 0-6 | 0-6 | 0-6 | 0-6 |

Laundry powder frame formulations according to the invention - continued:

| | Bleach containing Powder | | | | | |
|---|---|---|---|---|---|---|
| Alcohol ethoxylate 7EO | 1.2 | 5 | 4 | 0.5 | 0.5 | 0 |
| Coco fatty acid K12-18 | 0 | 0 | 0 | 0.3 | 0 | 0.6 |
| Fatty alcohol ether | 0 | 3.9 | 4.4 | 1.6 | 0 | 0 |
| sulphate | | | | | | |
| Linear alkyl benzene | 7.6 | 12.1 | 11.5 | 12.2 | 6.5 | 10.4 |
| sulphonic acid | | | | | | |
| Bleach activator | 0.2 | 9.5 | 9.5 | 0.5 | 0.8 | 2.2 |
| Percarbonate | 3.6 | 19.4 | 16.6 | 2.2 | 11.5 | 5.8 |
| AcetateNa | 0 | 6.7 | 7.1 | 0.3 | 1 | 0.7 |
| CitrateNa | 0 | 1.6 | 8.2 | 0.3 | 0.9 | 1.7 |
| Na Silicate | 3.6 | 11.3 | 16.4 | 10.2 | 9.1 | 16.5 |
| Na Carbonate | 21.6 | 8.7 | 1.4 | 8 | 22.9 | 14.8 |
| Na Phospahte | 0 | 0 | 0 | 0 | 0 | 0 |
| Na Hydrogencarbonate | 0.2 | 2.8 | 1.6 | 0.8 | 0.5 | 0.5 |
| Zeolite4A | 1.6 | 1.4 | 2.4 | 1.6 | 1.8 | 2.3 |
| HEDP | 0 | 0.27 | 0.16 | 0 | 0 | 0.17 |
| MGDA | 0 | 0 | 0 | 0 | 0 | 0 |
| Cellulase | 0-0.5 | 0-0.5 | 0-0.5 | 0-0.5 | 0-0.5 | 0-0.5 |
| Lipase | 0-0.4 | 0-0.4 | 0-0.4 | 0-0.4 | 0-0.4 | 0-0.4 |
| Mannanase | 0-0.4 | 0-0.4 | 0-0.4 | 0-0.4 | 0-0.4 | 0-0.4 |
| Protease | 0-1.5 | 0-1.5 | 0-1.5 | 0-1.5 | 0-1.5 | 0-1.5 |
| Amylase | 0-0.5 | 0-0.5 | 0-0.5 | 0-0.5 | 0-0.5 | 0-0.5 |
| Na Sulfate | 51 | 4 | 6 | 57 | 38 | 37 |
| Na Chloride | 1 | 1 | 0.5 | 1.2 | 0.2 | 1 |
| optical brightener | | 0.29 | 0.1 | 0.23 | 0.13 | 0.19 |
| Inventive Polymer(s) | 0.2-4 | 0.2-4 | 0.2-4 | 0.2-4 | 0.2-4 | 0.2-4 |
| (total) | | | | | | |
| Other polymers | 0-6 | 0-6 | 0-6 | 0-6 | 0-6 | 0-6 |

Further typical liquid detergent formulations LD1, LD2 and LD3 are shown in the following three tables:

Liquid detergent 1- LD1

| Liquid Detergent Formulation | |
|---|---|
| Sodium alkylbenzene sulfonic acid (C₁₀-C₁₃) LAS | 9.5% |
| C₁₃/C₁₅-Oxoalkohol reacted with 7 moles of EO | 4.5% |
| 1,2 propyleneglycol | 6% |
| ethanol | 2% |
| potassium coconut soap | 2.4% |
| NaOH | 2.2% |
| lauryl ether sulphate (Texapon) | 5.0% |
| Sodium citrate | 3% |
| Sokalan HP 20 | 2% |
| Inventive polymer or comparison | 0.2-2% |
| Graft polymer* | 2% |
| Water | to 100% |

Liquid detergent 2- LD2

| Liquid Detergent Formulation | |
|---|---|
| Sodium alkylbenzene sulfonic acid (C₁₀-C₁₃) | 5.5% |
| C₁₃/C₁₅-Oxoalkohol reacted with 7 moles of EO | 5.4% |
| 1,2 propyleneglycol | 6% |
| ethanol | 2% |
| potassium coconut soap | 2.4% |
| Monoethanolamine | 2.5% |
| lauryl ether sulphate | 5.4% |
| Sodium citrate | 3% |
| Sokalan HP96 | 2% |
| Inventive polymer or comparison | 0.1-1.5% |
| Graft polymer* | 2% |
| Water | to 100% |

Liquid detergent 3- LD3

| Liquid Detergent Formulation | |
|---|---|
| MGDA | 5.5% |
| APG, branched C13 Glucosid | 3.5% |
| 1,2 propyleneglycol | 6% |
| ethanol | 2% |
| potassium coconut soap | 4.4% |
| NaOH | 2.2% |
| lauryl ether sulphate | 9.5% |
| Sodium citrate | 3% |
| Inventive polymer or comparison | 0.1-1.2% |
| Graft polymer* | 2% |
| Water | to 100% |

All previous three tables:*(poly ethylene glycol of Mn 6000 g/mol as graft base, grafted with 60 weight % vinyl acetate (based on total polymer weight; produced following general disclosure of WO2007138054A1)

The specific embodiments as described throughout this disclosure are encompassed by the present invention as part of this invention; the various further options being disclosed in this present specification as “optional”, “preferred”, “more preferred”, “even more preferred” or “most preferred” (or “preferably” etc.) options of a specific embodiment may be individually and independently (unless such independent selection is not possible by virtue of the nature of that feature or if such independent selection is explicitly excluded) selected and then combined within any of the other embodiments (where other such options and preferences can be also selected individually and independently unless such independent selection is not possible by virtue of the nature of that feature or if such independent selection is explicitly excluded), with each and any and all such possible combinations being included as part of this invention as individual embodiments.

The following examples shall further illustrate the present invention without restricting the scope of the invention.

### EXAMPLES

### Polymer Measurements

K-value measures the relative viscosity of dilute polymer solutions and is a relative measure of the weight average molecular weight. As the weight average molecular weight of the polymer increases for a particular polymer, the K-value tends to also increase. The K-value is determined in a 3% by weight NaCl solution at 23° C. and a polymer concentration of 1% polymer according to the method of H. Fikentscher in “Cellulosechemie”, 1932, 13, 58.

The number average molecular weight (Mₙ), the weight average molecular weight (M_{w}) and the polydispersity M_{w}/Mₙ of the inventive graft polymers were determined by gel permeation chromatography in dimethylacetamide. The mobile phase (eluent) used was dimethylacetamide comprising 0.5 wt % LiBr. The concentration of graft polymer in tetrahydrofuran was 4.0 mg per mL. After filtration (pore size 0.2 μm), 100 μL of this solution were injected into the GPC system. Four columns (heated to 60° C.) were used for separation (PLgel precolumn, 3 PLgel MIXED-E column). The GPC system was operated at a flow rate of 1 mL per min. A DRI Agilent 1100 was used as the detection system. Poly (ethylene glycol) (PEG) standards (PL) having a molecular weight Mₙ from 106 to 1 378 000 g/mol were used for the calibration.

### Method for Measuring Polymer Biodegradability

Biodegradation in wastewater was tested in triplicate using the OECD 301F manometric respirometry method. 30 mg/mL test substance is inoculated into wastewater taken from Mannheim Wastewater Treatment Plant and incubated in a closed flask at 25° C. for 28 days. The consumption of oxygen during this time is measured as the change in pressure inside the flask using an OxiTop C (WTW). Evolved CO2 is absorbed using an NaOH solution. The amount of oxygen consumed by the microbial population during biodegradation of the test substance, after correction using a blank, is expressed as a % of the ThOD (Theoretical Oxygen Demand).

### Synthesis Procedures

For the inventive examples Ex. 1-Ex. 17 commercially available EO/PO polyether products and PEG polyethers were used as backbone materials. These products are available for example from BASF under the tradenames Pluriol®, Pluronic® or Breox®.

Structure details of the comparative and inventive polymer examples are listed in Table 1 and 2. The biodegradation data of comparative and inventive polymers at 28 day of the OECD 301F test is summarized in Tables 1 and 2.

### Synthesis Procedures for Comparative Examples

Copolymer of N-vinylpyrrolidone and 1-N-vinylimidazole, weight ratio 1:1; K-value Comp. Ex. I: approximately 30; obtainable as e.g. Sokalan HP 56 from BASF.

Comp. Ex. II: The polymer was prepared as described in WO03/042264 Example 1.

Comp Ex. III: A polymerization vessel equipped with stirrer and reflux condenser was initially charged with PEG (288.00 g) and water (629.00 g) under nitrogen atmosphere and heated to 80° C. Feed 1 (96.00 g of vinyl imidazole and 96.00 g of vinyl pyrrolidone), Feed 2 (3.20 g of tert-butyl peroxypivalate dissolved in 71.81 g of isopropanol) and Feed 3 (1.92 g of 2-mercaptoethanol in 98.08 g of water), were started simultaneously and dosed to the stirred vessel with constant feed rate in Feed 1 (6:00 h), Feed 2 (6:30 h) and Feed 3 (6:00 h). Upon completion of the feeds the mixture was stirred at 80° C. for 2:00 h. Feed 4 (1.28 g of tert-butyl peroxypivalate dissolved in 28.70 g of isopropanol) was dosed within 1:00 h with constant feed rate at 80° C. The mixture was stirred for 1:00 h at 80° C. upon complete addition of the feed. The polymerization mixture was diluted with 400 g of water and heated to 100° C. Steam distillation was conducted for 1:00 h at 100° C. to remove the volatiles. The yield was 1213 g of polymer solution.

Comp Ex. IV: A polymerization vessel equipped with stirrer and reflux condenser was initially charged with random EO/PO copolymer (288.00 g) and water (386.00 g) under nitrogen atmosphere and heated to 80° C. Feed 1 (96.00 g of vinyl imidazole and 96.00 g of vinyl pyrrolidone), Feed 2 (3.20 g of tert-butyl peroxypivalate dissolved in 71.81 g of isopropanol) and Feed 3 (1.92 g of 2-mercaptoethanol in 98.08 g of water), were started simultaneously and dosed to the stirred vessel with constant feed rate in Feed 1 (6:00 h), Feed 2 (6:30 h) and Feed 3 (6:00 h). Upon completion of the feeds the mixture was stirred at 80° C. for 2:00 h. Feed 4 (1.28 g of tert-butyl peroxypivalate dissolved in 28.70 g of isopropanol) was dosed within 1:00 h with constant feed rate at 80° C. The mixture was stirred for 1:00 h at 80° C. upon complete addition of the feed. The polymerization mixture was diluted with 600 g of water and heated to 100° C. Steam distillation was conducted for 1:00 h at 100° C. to remove the volatiles. The yield was 1813 g of polymer solution.

Comp Ex. V: A polymerization vessel equipped with stirrer and reflux condenser was initially charged with PEG (312.00 g) and water (312.00 g) under nitrogen atmosphere and heated to 80° C. Feed 2 (9.60 g of tert-butyl peroxypivalate dissolved in 21.91 g of tripropylene glycol) was started and 10 min upon the start of Feed 2, Feed 1 (96.00 g of vinyl imidazole and 72.00 g of vinyl pyrrolidone) and Feed 3 (1.92 g of 2-mercaptoethanol in 98.06 g of water) were started simultaneously. All Feeds were dosed to the stirred vessel with constant feed rate in Feed 1 (6:00 h), Feed 2 (6:40 h) and Feed 3 (6:00 h). Upon completion of the feeds the mixture was stirred at 80° C. for 2:00 h. Feed 4 (5.12 g of tert-butyl peroxypivalate dissolved in 11.69 g of tripropylene glycol) was dosed within 1:00 h with constant feed rate at 80° C. The mixture was stirred for 1:00 h at 80° C. upon complete addition of the feed. Water (268.10 g) was added and the polymerization mixture was heated to 100° C. Steam distillation was conducted for 1:00 h at 100° C. to remove the volatiles. The yield was 1232 g of polymer solution.

Comp. Ex. VI: A polymerization vessel equipped with stirrer and reflux condenser was initially charged with EO/PO random copolymer (240.00 g) and water (240.00 g) under nitrogen atmosphere and heated to 80° C. Feed 2 (9.60 g of tert-butyl peroxypivalate dissolved in 21.91 g of tripropylene glycol) was started and 10 min upon the start of Feed 2, Feed 1 (120.00 g of vinyl imidazole and 120.00 g of vinyl pyrrolidone) and Feed 3 (1.92 g of 2-mercaptoethanol in 122.06 g of water) were started simultaneously. All Feeds were dosed to the stirred vessel with constant feed rate in Feed 1 (6:00 h), Feed 2 (6:40 h) and Feed 3 (6:00 h). Upon completion of the feeds the mixture was stirred at 80° C. for 2:00 h. Feed 4 (5.12 g of tert-butyl peroxypivalate dissolved in 11.69 g of tripropylene glycol) was dosed within 1:00 h with constant feed rate at 80° C. The mixture was stirred for 1:00 h at 80° C. upon complete addition of the feed. Water (340.10 g) was added and the polymerization mixture was heated to 100° C. Steam distillation was conducted for 1:00 h at 100° C. to remove the volatiles. The yield was 1232 g of polymer solution.

### Synthesis Procedures for Inventive Examples Ex. 1-Ex. 17

Ex. 1: A polymerization vessel equipped with stirrer and reflux condenser was initially charged with PEG (336.00 g) and water (297.84 g) under nitrogen atmosphere and heated to 80° C. Feed 1 (96.00 g of vinyl imidazole and 48.00 g of vinyl pyrrolidone), Feed 2 (3.20 g of tert-butyl peroxypivalate dissolved in 71.81 g of isopropanol) and Feed 3 (1.92 g of 2-mercaptoethanol in 98.06 g of water), were started simultaneously and dosed to the stirred vessel with constant feed rate in Feed 1 (6:00 h), Feed 2 (6:30 h) and Feed 3 (6:00 h). Upon completion of the feeds the mixture was stirred at 80° C. for 2:00 h. Feed 4 (1.28 g of tert-butyl peroxypivalate dissolved in 28.70 g of isopropanol) was dosed within 1:00 h with constant feed rate at 80° C. The mixture was stirred for 1:00 h at 80° C. upon complete addition of the feed. The polymerization mixture was diluted with 400 g of water and heated to 100° C. Steam distillation was conducted for 1:00 h at 100° C. to remove the volatiles. The yield was 1132 g of polymer solution.

Ex. 2: A polymerization vessel equipped with stirrer and reflux condenser was initially charged with EO/PO blockcopolymer (336.00 g) and water (297.84 g) under nitrogen atmosphere and heated to 80° C. Feed 1 (72.00 g of vinyl imidazole and 72.00 g of vinyl pyrrolidone), Feed 2 (6.40 g of tert-butyl peroxypivalate dissolved in 71.81 g of isopropanol) and Feed 3 (1.92 g of 2-mercaptoethanol in 98.06 g of water), were started simultaneously and dosed to the stirred vessel with constant feed rate in Feed 1 (6:00 h), Feed 2 (6:30 h) and Feed 3 (6:00 h). Upon completion of the feeds water (333.75 g) was added and the mixture was stirred at 80° C. for 2:00 h. Feed 4 (2.56 g of tert-butyl peroxypivalate dissolved in 28.70 g of isopropanol) was dosed within 1:00 h with constant feed rate at 80° C. The mixture was stirred for 1:00 h at 80° C. upon complete addition of the feed. The polymerization mixture was heated to 100° C. Steam distillation was conducted for 1:00 h at 100° C. to remove the volatiles. The yield was 1356 g of polymer solution.

Ex. 3: A polymerization vessel equipped with stirrer and reflux condenser was initially charged with EO/PO blockcopolymer (360.00 g) and water (297.84 g) under nitrogen atmosphere and heated to 80° C. Feed 1 (60.00 g of vinyl imidazole and 60.00 g of vinyl pyrrolidone), Feed 2 (6.40 g of tert-butyl peroxypivalate dissolved in 71.81 g of isopropanol) and Feed 3 (1.92 g of 2-mercaptoethanol in 98.06 g of water), were started simultaneously and dosed to the stirred vessel with constant feed rate in Feed 1 (6:00 h), Feed 2 (6:30 h) and Feed 3 (6:00 h). Upon completion of the feeds water (333.75 g) was added and the mixture was stirred at 80° C. for 2:00 h. Feed 4 (2.56 g of tert-butyl peroxypivalate dissolved in 28.70 g of isopropanol) was dosed within 1:00 h with constant feed rate at 80° C. The mixture was stirred for 1:00 h at 80° C. upon complete addition of the feed. The polymerization mixture was heated to 100° C. Steam distillation was conducted for 1:00 h at 100° C. to remove the volatiles. The yield was 1242 g of polymer solution.

Ex. 4: A polymerization vessel equipped with stirrer and reflux condenser was initially charged with EO/PO blockcopolymer (384.00 g) and water (340.32 g) under nitrogen atmosphere and heated to 80° C. Feed 1 (48.00 g of vinyl imidazole and 48.00 g of vinyl pyrrolidone), Feed 2 (6.40 g of tert-butyl peroxypivalate dissolved in 71.81 g of isopropanol) and Feed 3 (1.92 g of 2-mercaptoethanol in 98.06 g of water), were started simultaneously and dosed to the stirred vessel with constant feed rate in Feed 1 (6:00 h), Feed 2 (6:30 h) and Feed 3 (6:00 h). Upon completion of the feeds water (300.00 g) was added and the mixture was stirred at 80° C. for 2:00 h. Feed 4 (2.56 g of tert-butyl peroxypivalate dissolved in 28.70 g of isopropanol) was dosed within 1:00 h with constant feed rate at 80° C. The mixture was stirred for 1:00 h at 80° C. upon complete addition of the feed. The polymerization mixture was heated to 100° C. Steam distillation was conducted for 1:00 h at 100° C. to remove the volatiles. The yield was 1428 g of polymer solution.

Ex. 5: A polymerization vessel equipped with stirrer and reflux condenser was initially charged with EO/PO blockcopolymer (400.00 g) and water (361.92 g) under nitrogen atmosphere and heated to 80° C. Feed 1 (36.00 g of vinyl imidazole and 36.00 g of vinyl pyrrolidone), Feed 2 (6.40 g of tert-butyl peroxypivalate dissolved in 71.81 g of isopropanol) and Feed 3 (1.92 g of 2-mercaptoethanol in 98.06 g of water), were started simultaneously and dosed to the stirred vessel with constant feed rate in Feed 1 (6:00 h), Feed 2 (6:30 h) and Feed 3 (6:00 h). Upon completion of the feeds water (280.00 g) was added and the mixture was stirred at 80° C. for 2:00 h. Feed 4 (2.56 g of tert-butyl peroxypivalate dissolved in 28.70 g of isopropanol) was dosed within 1:00 h with constant feed rate at 80° C. The mixture was stirred for 1:00 h at 80° C. upon complete addition of the feed. The polymerization mixture was heated to 100° C. Steam distillation was conducted for 1:00 h at 100° C. to remove the volatiles. The yield was 1323 g of polymer solution.

Ex. 6: A polymerization vessel equipped with stirrer and reflux condenser was initially charged with EO/PO blockcopolymer (336.00 g) and water (347.52 g) under nitrogen atmosphere and heated to 80° C. Feed 1 (96.00 g of vinyl imidazole and 48.00 g of vinyl pyrrolidone), Feed 2 (6.40 g of tert-butyl peroxypivalate dissolved in 24.00 g of tripropylene glycol) and Feed 3 (1.92 g of 2-mercaptoethanol in 98.06 g of water), were started simultaneously and dosed to the stirred vessel with constant feed rate in Feed 1 (6:00 h), Feed 2 (6:30 h) and Feed 3 (6:00 h). Upon completion of the feeds the mixture was stirred at 80° C. for 2:00 h. Feed 4 (2.56 g of tert-butyl peroxypivalate dissolved in 9.60 g of tripropylene glycol) was dosed within 1:00 h with constant feed rate at 80° C. The mixture was stirred for 1:00 h at 80° C. upon complete addition of the feed. Water (254.00 g) was added and the polymerization mixture was heated to 100° C. Steam distillation was conducted for 1:00 h at 100° C. to remove the volatiles. The yield was 1252 g of polymer solution.

Ex. 7: A polymerization vessel equipped with stirrer and reflux condenser was initially charged with PEG (360.00 g) and water (347.52 g) under nitrogen atmosphere and heated to 80° C. Feed 1 (84.00 g of vinyl imidazole and 36.00 g of vinyl pyrrolidone), Feed 2 (12.80 g of tert-butyl peroxypivalate dissolved in 28.00 g of tripropylene glycol) and Feed 3 (1.92 g of 2-mercaptoethanol in 98.06 g of water), were started simultaneously and dosed to the stirred vessel with constant feed rate in Feed 1 (6:00 h), Feed 2 (6:30 h) and Feed 3 (6:00 h). Upon completion of the feeds the mixture was stirred at 80° C. for 2:00 h. Feed 4 (2.56 g of tert-butyl peroxypivalate dissolved in 5.60 g of tripropylene glycol) was dosed within 1:00 h with constant feed rate at 80° C. The mixture was stirred for 1:00 h at 80° C. upon complete addition of the feed. Water (257.00 g) was added and the polymerization mixture was heated to 100° C. Steam distillation was conducted for 1:00 h at 100° C. to remove the volatiles. The yield was 1313 g of polymer solution.

Ex. 8: A polymerization vessel equipped with stirrer and reflux condenser was initially charged with PEG (360.00 g) and water (347.52 g) under nitrogen atmosphere and heated to 80° C. Feed 2 (9.60 g of tert-butyl peroxypivalate dissolved in 21.91 g of tripropylene glycol) was started and 10 min upon the start of Feed 2, Feed 1 (96.00 g of vinyl imidazole and 24.00 g of vinyl pyrrolidone) and Feed 3 (1.92 g of 2-mercaptoethanol in 98.06 g of water), were started simultaneously. All Feeds were dosed to the stirred vessel with constant feed rate in Feed 1 (6:00 h), Feed 2 (6:40 h) and Feed 3 (6:00 h). Upon completion of the feeds the mixture was stirred at 80° C. for 2:00 h. Feed 4 (5.12 g of tert-butyl peroxypivalate dissolved in 11.69 g of tripropylene glycol) was dosed within 1:00 h with constant feed rate at 80° C. The mixture was stirred for 1:00 h at 80° C. upon complete addition of the feed. Water (257.00 g) was added and the polymerization mixture was heated to 100° C. Steam distillation was conducted for 1:00 h at 100° C. to remove the volatiles. The yield was 1246 g of polymer solution.

Ex. 9: A polymerization vessel equipped with stirrer and reflux condenser was initially charged with PEG (360.00 g) and water (347.52 g) under nitrogen atmosphere and heated to 80° C. Feed 2 (12.80 g of tert-butyl peroxypivalate dissolved in 24.00 g of tripropylene glycol) was started and 10 min upon the start of Feed 2, Feed 1 (72.00 g of vinyl imidazole and 48.00 g of vinyl pyrrolidone) and Feed 3 (1.92 g of 2-mercaptoethanol in 98.06 g of water) were started simultaneously. All Feeds were dosed to the stirred vessel with constant feed rate in Feed 1 (6:00 h), Feed 2 (6:40 h) and Feed 3 (6:00 h). Upon completion of the feeds the mixture was stirred at 80° C. for 2:00 h. Feed 4 (5.12 g of tert-butyl peroxypivalate dissolved in 9.60 g of tripropylene glycol) was dosed within 1:00 h with constant feed rate at 80° C. The mixture was stirred for 1:00 h at 80° C. upon complete addition of the feed. Water (257.00 g) was added and the polymerization mixture was heated to 100° C. Steam distillation was conducted for 1:00 h at 100° C. to remove the volatiles. The yield was 1252 g of polymer solution.

Ex. 10: A polymerization vessel equipped with stirrer and reflux condenser was initially charged with PEG (384.00 g) and water (384.00 g) under nitrogen atmosphere and heated to 80° C. Feed 2 (9.60 g of tert-butyl peroxypivalate dissolved in 21.91 g of tripropylene glycol) was started and 10 min upon the start of Feed 2, Feed 1 (60.00 g of vinyl imidazole and 36.00 g of vinyl pyrrolidone) and Feed 3 (1.92 g of 2-mercaptoethanol in 122.06 g of water) were started simultaneously. All Feeds were dosed to the stirred vessel with constant feed rate in Feed 1 (6:00 h), Feed 2 (6:40 h) and Feed 3 (6:00 h). Upon completion of the feeds the mixture was stirred at 80° C. for 2:00 h. Feed 4 (5.12 g of tert-butyl peroxypivalate dissolved in 11.69 g of tripropylene glycol) was dosed within 1:00 h with constant feed rate at 80° C. The mixture was stirred for 1:00 h at 80° C. upon complete addition of the feed. Water (196.10 g) was added and the polymerization mixture was heated to 100° C. Steam distillation was conducted for 1:00 h at 100° C. to remove the volatiles. The yield was 1232 g of polymer solution.

Ex. 11: A polymerization vessel equipped with stirrer and reflux condenser was initially charged with EO/PO copolymer (336.00 g) and water (336.00 g) under nitrogen atmosphere and heated to 80° C. Feed 2 (9.60 g of tert-butyl peroxypivalate dissolved in 21.91 g of tripropylene glycol) was started and 10 min upon the start of Feed 2, Feed 1 (84.00 g of vinyl imidazole and 60.00 g of vinyl pyrrolidone) and Feed 3 (1.92 g of 2-mercaptoethanol in 122.06 g of water) were started simultaneously. All Feeds were dosed to the stirred vessel with constant feed rate in Feed 1 (6:00 h), Feed 2 (6:40 h) and Feed 3 (6:00 h). Upon completion of the feeds the mixture was stirred at 80° C. for 2:00 h. Feed 4 (5.12 g of tert-butyl peroxypivalate dissolved in 11.69 g of tripropylene glycol) was dosed within 1:00 h with constant feed rate at 80° C. The mixture was stirred for 1:00 h at 80° C. upon complete addition of the feed. Water (244.10 g) was added and the polymerization mixture was heated to 100° C. Steam distillation was conducted for 1:00 h at 100° C. to remove the volatiles. The yield was 1232 g of polymer solution.

Ex. 12: A polymerization vessel equipped with stirrer and reflux condenser was initially charged with EO/PO copolymer (360.00 g) and water (360.00 g) under nitrogen atmosphere and heated to 80° C. Feed 2 (9.60 g of tert-butyl peroxypivalate dissolved in 21.91 g of tripropylene glycol) was started and 10 min upon the start of Feed 2, Feed 1 (96.00 g of vinyl imidazole and 24.00 g of vinyl pyrrolidone) and Feed 3 (1.92 g of 2-mercaptoethanol in 122.06 g of water) were started simultaneously. All Feeds were dosed to the stirred vessel with constant feed rate in Feed 1 (6:00 h), Feed 2 (6:40 h) and Feed 3 (6:00 h). Upon completion of the feeds the mixture was stirred at 80° C. for 2:00 h. Feed 4 (5.12 g of tert-butyl peroxypivalate dissolved in 11.69 g of tripropylene glycol) was dosed within 1:00 h with constant feed rate at 80° C. The mixture was stirred for 1:00 h at 80° C. upon complete addition of the feed. Water (220.10 g) was added and the polymerization mixture was heated to 100° C. Steam distillation was conducted for 1:00 h at 100° C. to remove the volatiles. The yield was 1232 g of polymer solution.

Ex. 13: A polymerization vessel equipped with stirrer and reflux condenser was initially charged with EO/PO random copolymer (384.00 g) and water (384.00 g) under nitrogen atmosphere and heated to 80° C. Feed 2 (9.60 g of tert-butyl peroxypivalate dissolved in 21.91 g of tripropylene glycol) was started and 10 min upon the start of Feed 2, Feed 1 (24.00 g of vinyl imidazole and 72.00 g of vinyl pyrrolidone) and Feed 3 (1.92 g of 2-mercaptoethanol in 122.06 g of water) were started simultaneously. All Feeds were dosed to the stirred vessel with constant feed rate in Feed 1 (6:00 h), Feed 2 (6:40 h) and Feed 3 (6:00 h). Upon completion of the feeds the mixture was stirred at 80° C. for 2:00 h. Feed 4 (5.12 g of tert-butyl peroxypivalate dissolved in 11.69 g of tripropylene glycol) was dosed within 1:00 h with constant feed rate at 80° C. The mixture was stirred for 1:00 h at 80° C. upon complete addition of the feed. Water (220.10 g) was added and the polymerization mixture was heated to 100° C. Steam distillation was conducted for 1:00 h at 100° C. to remove the volatiles. The yield was 1256 g of polymer solution.

Ex. 14: A polymerization vessel equipped with stirrer and reflux condenser was initially charged with PEG (408.00 g) and water (408.00 g) under nitrogen atmosphere and heated to 80° C. Feed 2 (9.60 g of tert-butyl peroxypivalate dissolved in 21.91 g of tripropylene glycol) was started and 10 min upon the start of Feed 2, Feed 1 (48.00 g of vinyl imidazole and 24.00 g of vinyl pyrrolidone) and Feed 3 (1.92 g of 2-mercaptoethanol in 122.06 g of water) were started simultaneously. All Feeds were dosed to the stirred vessel with constant feed rate in Feed 1 (6:00 h), Feed 2 (6:40 h) and Feed 3 (6:00 h). Upon completion of the feeds the mixture was stirred at 80° C. for 2:00 h. Feed 4 (5.12 g of tert-butyl peroxypivalate dissolved in 11.69 g of tripropylene glycol) was dosed within 1:00 h with constant feed rate at 80° C. The mixture was stirred for 1:00 h at 80° C. upon complete addition of the feed. Water (172.10 g) was added and the polymerization mixture was heated to 100° C. Steam distillation was conducted for 1:00 h at 100° C. to remove the volatiles. The yield was 1232 g of polymer solution.

Ex. 15: A polymerization vessel equipped with stirrer and reflux condenser was initially charged with PEG (396.00 g) and water (396.00 g) under nitrogen atmosphere and heated to 80° C. Feed 2 (9.60 g of tert-butyl peroxypivalate dissolved in 21.91 g of tripropylene glycol) was started and 10 min upon the start of Feed 2, Feed 1 (48.00 g of vinyl imidazole and 36.00 g of vinyl pyrrolidone) and Feed 3 (1.92 g of 2-mercaptoethanol in 122.06 g of water) were started simultaneously. All Feeds were dosed to the stirred vessel with constant feed rate in Feed 1 (6:00 h), Feed 2 (6:40 h) and Feed 3 (6:00 h). Upon completion of the feeds the mixture was stirred at 80° C. for 2:00 h. Feed 4 (5.12 g of tert-butyl peroxypivalate dissolved in 11.69 g of tripropylene glycol) was dosed within 1:00 h with constant feed rate at 80° C. The mixture was stirred for 1:00 h at 80° C. upon complete addition of the feed. Water (184.10 g) was added and the polymerization mixture was heated to 100° C. Steam distillation was conducted for 1:00 h at 100° C. to remove the volatiles. The yield was 1232 g of polymer solution.

Ex. 16: A polymerization vessel equipped with stirrer and reflux condenser was initially charged with PEG (408.00 g) and water (361.00 g) under nitrogen atmosphere and heated to 80° C. Feed 2 (6.40 g of tert-butyl peroxypivalate dissolved in 71.91 g of isopropanol) was started and 10 min upon the start of Feed 2, Feed 1 (36.00 g of vinyl imidazole and 36.00 g of vinyl pyrrolidone) and Feed 3 (1.92 g of 2-mercaptoethanol in 98.06 g of water) were started simultaneously. All Feeds were dosed to the stirred vessel with constant feed rate in Feed 1 (6:00 h), Feed 2 (6:40 h) and Feed 3 (6:00 h). Upon completion of the feeds the mixture was stirred at 80° C. for 2:00 h. Feed 4 (2.56 g of tert-butyl peroxypivalate dissolved in 28.70 g of isopropanol) was dosed within 1:00 h with constant feed rate at 80° C. The mixture was stirred for 1:00 h at 80° C. upon complete addition of the feed. Water (271.00 g) was added and the polymerization mixture was heated to 100° C. Steam distillation was conducted for 1:00 h at 100° C. to remove the volatiles. The yield was 1221 g of polymer solution.

Ex. 17: A polymerization vessel equipped with stirrer and reflux condenser was initially charged with PEG (408.00 g), water (361.92 g), vinyl imidazole (36.00 g) and vinyl pyrrolidone (36.00 g) under nitrogen atmosphere and heated to 80° C. Feed 1 (6.40 g of tert-butyl peroxypivalate dissolved in 24.00 g of tripropylene glycol) and Feed 2 (1.92 g of 2-mercaptoethanol in 98.06 g of water) were started simultaneously. All Feeds were dosed to the stirred vessel with constant feed rate in Feed 1 (3:30 h), Feed 2 (2:00 h). Upon completion of the feeds the mixture was stirred at 80° C. for 2:00 h. Feed 3 (2.56 g of tert-butyl peroxypivalate dissolved in 9.60 g g of tripropylen glacol) was dosed within 1:00 h with constant feed rate at 80° C. The mixture was stirred for 1:00 h at 80° C. upon complete addition of the feed. Water (237.00 g) was added and the polymerization mixture was heated to 100° C. Steam distillation was conducted for 1:00 h at 100° C. to remove the volatiles. The yield was 1221 g of polymer solution.

Ex. 18: A polymerization vessel equipped with stirrer and reflux condenser was initially charged with PEG (289.00 g), water (340 g), vinyl imidazole (25.50 g) and vinyl pyrrolidone (25.50 g) under nitrogen atmosphere and heated to 80° C. Feed 1 (3.40 g of Wako V50 dissolved in 52.7 g of water) and Feed 2 (0.68 g of 2-mercaptoethanol in 29.9 g of water) were started simultaneously. All Feeds were dosed to the stirred vessel with constant feed rate in Feed 1 (3:30 h), Feed 2 (2:00 h). Upon completion of the feeds the mixture was stirred at 80° C. for 2:00 h. Feed 3 (1.36 g of Wako V50 dissolved in 21.1 g of Water) was dosed within 1:00 h with constant feed rate at 80° C. The mixture was stirred for 1:00 h at 85° C. upon complete addition of the feed. Water (71.40 g) was added and the polymerization mixture was heated to 100° C. Steam distillation was conducted for 1:00 h at 100° C. to remove the volatiles. The yield was 859 g of polymer solution.

TABLE 1

| | | | | | Weight Ratio of | |
|---|---|---|---|---|---|---|
| | | | | | Polymer | |
| | Polymer | | | | Backbone to | |
| | Backbone | Polymer | Polymer | Sidechain | Sidechain | |
| | Mₙ | Backbone | Backbone | Monomers | Monomers | Biodegradation |
| Example | [g/mol] | % EO | Structure | (B1/B2) | (A):(B1):(B2) | [%], 28 d |
| Comp. | — | — | — | VI/VP | 0:50:50 | 0 |
| Ex. I | | | | | | |
| Comp. | 1500 | 100 | C | VI/VP | 20:25:55 | 12 |
| Ex. II | | | | | | |
| Comp | 4000 | 100 | C | VI/VP | 60:20:20 | 43 |
| Ex. III | | | | | | |
| Comp | 3000 | 60 | B | VI/VP | 60:20:20 | 41 |
| Ex. IV | | | | | | |
| Comp | 4000 | 100 | C | VI/VP | 65:20:15 | 36 |
| Ex. V | | | | | | |
| Comp | 1950 | 50 | A2 | VI/VP | 50:25:25 | 37 |
| Ex. VI | | | | | | |

TABLE 2
Inventive examples

| | Polymer | Polymer | Polymer | Sidechain | Total amount of | Weight Ratio of Polymer | Biodegradati |
|---|---|---|---|---|---|---|---|
| | Backbone | Backbone | Backbone | Monomers | Monomers | Backbone to Sidechain | on [%], |
| Example | Mₙ [g/mol] | % EO | Structure | (B1)/(B2) | (B1) + (B2) | Monomers (A):(B1):(B2) | 28 d |
| Ex. 1 | 1500 | 100 | C | VI/VP | 30 | 70:20:10 | 54 |
| Ex. 2 | 2900 | 40 | A1 | VI/VP | 30 | 70:15:15 | 50 |
| Ex. 3 | 2900 | 40 | A1 | VI/VP | 25 | 75:12.5:12.5 | 56 |
| Ex. 4 | 2900 | 40 | A1 | VI/VP | 20 | 80:10:10 | 54 |
| Ex. 5 | 2900 | 40 | A1 | VI/VP | 25 | 85:7.5:7.5 | 65 |
| Ex. 6 | 2650 | 40 | A2 | VI/VP | 30 | 70:20:10 | 53 |
| Ex. 7 | 1500 | 100 | C | VI/VP | 25 | 75:17.5:7.5 | 51 |
| Ex. 8 | 1500 | 100 | C | VI/VP | 25 | 75:20:5 | 54 |
| Ex. 9 | 1500 | 100 | C | VI/VP | 25 | 75:15:10 | 54 |
| Ex. 10 | 600 | 100 | C | VI/VP | 20 | 80:12.5:7.5 | 61- |
| Ex. 11 | 1950 | 50 | A2 | VI/VP | 30 | 70:17.5:12.5 | 52- |
| Ex. 12 | 1950 | 50 | A2 | VI/VP | 25 | 75:20:5 | 56- |
| Ex. 13 | 2500 | 60 | B | VI/VP | 20 | 80:5:15 | -55 |
| Ex. 14 | 1500 | 100 | C | VI/VP | 15 | 85:10:5 | 64- |
| Ex. 15 | 1500 | 100 | C | VI/VP | 27.5 | 82.5:10:7.5 | 59- |
| Ex. 16 | 1500 | 100 | C | VI/VP | 15 | 85:7.5:7.5 | 62 |
| Ex. 17 | 1500 | 100 | C | VI/VP | 15 | 85:7.5:7.5 | 63 |
| Ex. 18 | 1500 | 100 | C | VI/VP | 15 | 85:7.5:7.5 | 61 |

VAc = Vinyl acetate;
VI = Vinyl imidazole;
VP = Vinyl pyrrolidone;
A1: EO/PO/EO triblock backbone;
A2: PO/EO/PO triblock backbone;
B: random EO/PO copolymer
C: PEG;

### Evaluation of DTI Performance (Laundry Experiments)

### Wash Results:

Selected color fabric (EMPA 130 and EMPA 133 as dye donor) was washed at 60° C. in the presence of white test fabric and polyester ballast fabric with addition of the dye transfer inhibitor. The liquid detergent based upon a mixture of anionic and noninonic surfactants (LAS; AES, AEO). After the wash cycle, the fabric was rinsed, spun and dried. In order to determine the dye transfer inhibiting effect, the staining of the white test fabric was ascertained photometrically. The reflectance was determined with a Datacolor photometer (Elrepho 2000) at 520 nm (EMPA 130) or at 600 nm (EMPA 133).

Composition of the liquid detergent

| Ingredient | [% by weight] |
|---|---|
| Linear dodecylbenzenesulfonic acid | 5.5 |
| C12C14 fatty alcohol ether sulfate, Na salt | 5.4 |
| C13C15 oxo process alcohol with 7 EO | 5.4 |
| Coconut fatty acid K 12-18 | 2.4 |
| 1,2 propylene glycol | 6.0 |
| Ethanol | 2.0 |
| NaOH | 2.2 |
| Sodium citrate | 3.0 |
| DTI additive | 0.5/1.0 active material |
| Water | to 100 |

Wash conditions

| Machine | Launder-o-meter, LP2 type, SDL Atlas Inc., USA | |
|---|---|---|
| Detergent dosage | 4 | g/L |
| Wash liquor | 250 ml water | |
| Water hardness | Ca²⁺:Mg²⁺:HCO3⁻ 4:1:8 | |
| Wash cycle | 1 | |
| Fabric/liquor ratio | 1:12.5 | |
| Wash duration | 20 | min |
| Wash temperature | 60° | C. |

| | |
|---|---|
| Color fabric | 1 g EMPA 130 |
| | 1 g EMPA 133 |
| Test fabric | 10 g wfk 10 A |
| | 5 g wfl 20 A |
| Ballast fabric | 5 g wfk 30 A, polyester fabric |

### Explanation of Abbreviations in Previous Table

wfk 10 A: cotton fabric, reflectance 83.4% (520 nm), 84.5% (600 nm)
wfk 20 A: polyester-cotton fabric, reflectance 83.8% (520 nm), 83.3% (600 nm)
EMPA 130: cotton fabric dyed with Direct Red 83.1
EMPA 133: cotton fabric dyed with Direct Blue71
Manufacturer/supplier: wfk Testgewebe GmbH, Bruggen, Germany; EMPA Testmaterialien AG, Sankt Gallen, Switzerland

Wash result for EMPA 130 and EMPA 133 color fabric (evaluation of % reflectance)

| | | % | % | % | % |
|---|---|---|---|---|---|
| | Dosage | reflectance | reflectance | reflectance | reflectance |
| | DTI (two | wfk 10 A | wfk 20 A | wfk 10 A | wfk 20 A |
| | examples | (washed | (washed | (washed | (washed |
| | per DTI- | with EMPA | with EMPA | with EMPA | with EMPA |
| | polymer) | 130) | 130) | 133) | 133) |
| No DTI | | 66.0 | 68.9 | 45.5 | 49.5 |
| Comp. Ex. I | 0.5 wt. % | 82.7 | 82.2 | 79.2 | 80.4 |
| | 1.0 wt. % | 82.9 | 82.2 | 82.2 | 81.6 |
| Comp. Ex. II | 0.5 wt. % | 66.2 | 69.2 | 48.5 | 54.9 |
| | 1.0 wt. % | 66.3 | 69.4 | 49.9 | 55.5 |
| Comp Ex. III | 0.5 wt. % | 81.5 | 82.4 | 71.7 | 75.2 |
| | 1.0 wt. % | 82.4 | 82.9 | 81.0 | 81.5 |
| Comp Ex. IV | 0.5 wt. % | 81.3 | 82.2 | 72.1 | 74.7 |
| | 1.0 wt. % | 82.8 | 82.8 | 78.8 | 78.6 |
| Comp Ex. V | 0.5 wt. % | 84.39 | 82.58 | 66.52 | 71.65 |
| | 1.0 wt. % | 84.72 | 82.53 | 78.84 | 79.31 |
| Comp Ex. VI | 0.5 wt. % | 84.11 | 81.08 | 70.83 | 68.02 |
| | 1.0 wt. % | 84.52 | 81.44 | 79.24 | 79.60 |
| Ex. 1 | 0.5 wt. % | 84.02 | 82.07 | 61.65 | 65.76 |
| | 1.0 wt. % | 84.73 | 82.04 | 76.15 | 77.63 |
| Ex. 2 | 0.5 wt. % | 83.43 | 81.44 | 72.49 | 64.85 |
| | 1.0 wt. % | 83.97 | 81.50 | 79.72 | 76.06 |
| Ex. 3 | 0.5 wt. % | 82.86 | 81.54 | 67.50 | 60.42 |
| | 1.0 wt. % | 84.16 | 81.82 | 77.48 | 73.77 |
| Ex. 4 | 0.5 wt. % | 83.29 | 80.88 | 71.09 | 64.20 |
| | 1.0 wt. % | 84.07 | 81.34 | 78.96 | 76.15 |
| Ex. 5 | 0.5 wt. % | 81.76 | 81.09 | 62.93 | 53.66 |
| | 1.0 wt. % | 82.78 | 81.47 | 67.20 | 60.16 |
| Ex. 6 | 0.5 wt. % | 83.74 | 79.94 | 65.29 | 68.59 |
| | 1.0 wt. % | 83.99 | 80.02 | 78.98 | 78.28 |
| Ex. 7 | 0.5 wt. % | 83.17 | 81.73 | 58.59 | 63.12 |
| | 1.0 wt. % | 83.92 | 81.97 | 72.17 | 75.13 |
| Ex. 8 | 0.5 wt. % | 83.18 | 81.66 | 59.62 | 62.36 |
| | 1.0 wt. % | 84.17 | 81.76 | 72.81 | 75.49 |
| Ex. 9 | 0.5 wt. % | 82.98 | 81.73 | 58.35 | 61.46 |
| | 1.0 wt. % | 83.66 | 82.15 | 70.05 | 73.40 |
| Ex. 10 | 0.5 wt. % | 83.51 | 82.32 | 55.47 | 58.27 |
| | 1.0 wt. % | 84.01 | 82.70 | 67.07 | 70.05 |
| Ex. 11 | 0.5 wt. % | 83.94 | 81.49 | 66.38 | 62.73 |
| | 1.0 wt. % | 84.52 | 81.35 | 77.37 | 77.20 |
| Ex. 12 | 0.5 wt. % | 83.61 | 81.73 | 61.84 | 58.97 |
| | 1.0 wt. % | 84.29 | 81.53 | 76.25 | 72.68 |
| Ex. 13 | 0.5 wt. % | 81.92 | 81.41 | 56.50 | 50.12 |
| | 1.0 wt. % | 82.78 | 81.92 | 63.70 | 56.99 |
| Ex. 14 | 0.5 wt. % | 82.84 | 82.01 | 55.19 | 58.42 |
| | 1.0 wt. % | 83.37 | 82.29 | 58.61 | 62.10 |
| Ex. 15 | 0.5 wt. % | 82.80 | 82.00 | 53.12 | 56.61 |
| | 1.0 wt. % | 83.69 | 82.52 | 61.46 | 65.20 |
| Ex. 16 | 0.5 wt. % | 82.70 | 81.53 | 50.15 | 54.26 |
| | 1.0 wt. % | 83.84 | 81.72 | 53.33 | 59.13 |
| Ex. 17 | 0.5 wt. % | 81.17 | 81.28 | 54.61 | 56.94 |
| | 1.0 wt. % | 82.31 | 81.94 | 64.04 | 67.40 |

Example for Combinations of New Polymers with 2-Phenoxyethanol and DCPP (Tinosan HP 100) Based on a Standard Liquid Laundry Detergent Formulation

Liquid laundry detergent formulations are prepared containing 2% by weight of the inventive polymer of example 5 and/or 0.3% of the biocide Tinosan® HP 100 (from BASF) and/or 1% phenoxyethanol (Protectol® PE, BASF). The formulations are prepared by first preparing a premix, containing surfactants, solvents, fatty acid, citric acid and NaOH, as shown in the table, and water up to 90%. This pre-mix is prepared by adding all components to the appropriate amount of water and stirring at room temperature. Subsequently, the pH is set to pH=8.5 using NaOH. Then the final formulations are prepared by stirring at room temperature: 90% of this pre-mix, the appropriate concentrations of the present polymer and/or Tinosan® HP 100 (commercial product of BASF SE containing 30% of the antimicrobial active 4,4′-dichoro 2-hydroxydiphenylether (CAS 3380-30-1)) and/or 2-phenoxyethanol (CAS 122-99-6) and water up 100%. For the purpose of comparison, a standard liquid detergent formulation neither containing a polymer of the invention nor a biocide is prepared. The turbidity was determined by measuring the Nephelometric Turbidity Unit (NTU) with a photometer (Hanna Instruments, HI-88703-02) at 23° C., using a 25 mm round cuvette made from special optical glass. The measurement of the iodine color is done using a photometer (Hack Lange, Lico 150) at 23° C. with a polystyrene cuvette with 1 cm pathlength.

Compositions and results are shown in the following table.

| | Formulation A | Formulation B | Formulation C | Formulation D |
|---|---|---|---|---|
| Ingredient | (comparative) | (comparative) | (inventive) | (inventive) |
| AEO | 5.4% | 5.4% | 5.4% | 5.4% |
| AES | 7.7% | 7.7% | 7.7% | 7.7% |
| LAS | 5.5% | 5.5% | 5.5% | 5.5% |
| Coco-fatty acid | 2.4% | 2.4% | 2.4% | 2.4% |
| citric acid | 3% | 3% | 3% | 3% |
| 1,2-propanediol | 6% | 6% | 6% | 6% |
| ethanol | 2% | 2% | 2% | 2% |
| Polymer from example 5 | — | — | 2% | 2% |
| Tinosan ® HP 100 | 0.3% | | 0.3% | |
| Phenoxyethanol | — | 1% | | 1% |
| NaOH | Up to pH = 8.5 | Up to pH = 8.5 | Up to pH = 8.5 | Up to pH = 8.5 |
| Water | Up to 100% | Up to 100% | Up to 100% | Up to 100% |
| Appearance | Clear, slightly | Clear, slightly | Clear, slightly | Clear, slightly |
| | yellow, | yellow, | yellow, | yellow, |
| | viscous liquid | viscous liquid | viscous liquid | viscous liquid |
| Turbidity (NTU) | 1 | 1 | 3 | 3 |
| Color value (iodine) | 0.6 | 0.3 | 0.6 | 0.5 |

Abbreviations used:
AEO: C12/C14 fatty alcohol (7EO) Lutensol AO7 (BASF) (CAS 68002-97-1)
AES: Alcohol Ethoxysulfate: Texapon N 70 (BASF) (CAS 68891-38-3)
LAS: Linear alkylbenzene sulfonate Maranil DBS/LC (BASF) (CAS 85536-14-7)
Coco fatty acid: Edenor K12-18 (Emery Oleochemicals) (CAS 90990-15-1)
1,2-propanediol: racemic mixture (CAS 57-55-6)
In the table above the concentrations of the surfactant trade products are given.

### Abbreviations Used

AEO: C12/C14 fatty alcohol (7EO) Lutensol AO7 (BASF) (CAS 68002-97-1)
AES: Alcohol Ethoxysulfate: Texapon N 70 (BASF) (CAS 68891-38-3)
LAS: Linear alkylbenzene sulfonate Maranil DBS/LC (BASF) (CAS 85536-14-7)
Coco fatty acid: Edenor K12-18 (Emery Oleochemicals) (CAS 90990-15-1)
1,2-propanediol: racemic mixture (CAS 57-55-6)

In the table above the concentrations of the surfactant trade products are given.

It is clear from the above table, that the present polymer according to example 5 and Tinosan HP 100 or phenoxyethanol can be combined in a liquid laundry formulation without any instability or significant turbidity.

1. A graft polymer, comprising:
(A) a polymer backbone as a graft base; and
(B) polymeric sidechains grafted onto the polymer backbone (A);
wherein:
the polymer backbone (A) comprises structural units derived from at least one monomer selected from the group consisting of C2- to C10-alkylene oxides;
when structural units based on more than one alkylene oxide monomer are present, the polymer backbone (A) is a random polymer, a block polymer, or a polymer comprising mixed structures of block units, with each block being a homo-block or a random block itself, and statistical/random parts comprised of two or more alkylene oxides;
a number average molecular weight Mn of the polymer backbone (A) in g/mol is 400 to 12,000;
the polymeric sidechains (B) comprise structural units derived from at least one monomer (B1) and at least one monomer (B2):
(B1) is an olefinically unsaturated amine-containing monomer; and
(B2) is a further nitrogen-containing monomer;
the polymeric sidechains (B) optionally comprise at least one structural unit derived from a monomer other than (B1) and (B2) selected the group consisting of a vinyl oxazolidinone, 4-vinyl pyridine-N-oxide, N-vinyl formamide (and its amine if hydrolyzed after polymerization, N-vinyl acetamide, N-vinyl-N-methyl acetamide, acrylamide, methyl acrylamide, and N,N′-di alkyl (meth) acrylamide;
the polymeric sidechains (B) are substantially free of vinyl ester monomers; and
based on a total weight of the graft polymer:
an amount of the polymer backbone (A) is 70 to 95 wt %;
an amount of polymeric side chains (B) is 5 to 30 wt %;
an amount of (B1) 4 to 29 wt %;
an amount of (B2) 1 to 15 wt, %;
the amount of (B2) does exceed 4-times the amount of (B1); and
the amount of structural units derived from monomers other than (B1) and (B2) is at most 50% of the amount of (B1) and not more than the amount of (B2).

2. The graft polymer according to claim 1, wherein the polymer backbone (A) comprises structural units derived from ethylene oxide (EO) and optionally at least one further monomer selected from 1,2-propylene oxide (PO) and 1,2-butylene oxide, with a relative amount of EO in the polymer backbone (A) being 10 to 100 wt % in relation to a total molar amount of alkylene oxides in the polymer backbone (A).

3. The graft polymer according to claim 2, wherein the backbone is selected from the group consisting of:
i) a poly (ethylene oxide), and
ii) a polyalkylene oxide comprising only ethylene oxide (EO) and propylene-oxide (PO).

4. The graft polymer according to claim 1, wherein:
i) the graft polymer has a polydispersity Mw/Mn of up to 3, with Mw being weight average molecular weight in g/mol and Mn being number average molecular weight in g/mol,
and/or
ii) the polymer backbone (A) is capped at one or both end groups with a C1-C25-alkyl group,
and/or
ii) a bio-degradability of the graft polymer is at least 40% within 28 days when tested under OECD301F.

5. The graft polymer according to claim 1, wherein:
(A) the polymer backbone (A) comprises only ethylene oxide as monomer, and the number average molecular weight of the polymer backbone (A) in g/mol is 400 to 3,000;
and
(B) the polymeric side chains consist of structural units derived from the following monomers:
(B1) 1-vinyl imidazole, and
(B2) an N-vinyl lactam.

6. The graft polymer according to claim 1, wherein:
(A) the polymer backbone (A) is a tri-block polymer EO/PO/EO, and the number average molecular weight of the polymer backbone (A) in g/mol is within 400 to 3,000, with a relative amount of EO in the polymer backbone (A) being 10-90 wt % in relation to a total molar amount of alkylene oxides in the polymer backbone (A);
and
(B) the polymeric side chains consist of structural units derived from the following monomers:
(B1) 1-vinyl imidazole; and
(B2) an N-vinyl lactam.

7. The polymer according to claim 1, wherein, based on a total weight of the graft polymer:
the amount of the polymer backbone (A) is 75 to 85 wt %;
the amount of polymeric side chains (B) is 15 to 25 wt %;
the amount of (B1) is to 24 wt %;
the amount of (B2) is 1 to 15 wt %; and
optionally the amount of (B2) is the same as the amount of (B1).

8. A process for obtaining the graft polymer according to claim 1, comprising polymerizing the monomer (B1), the monomer (B2), and optionally the monomer other than (B1) and (B2) in the presence of the polymer backbone (A), wherein the polymeric sidechains (B) are obtained by radical polymerization, using radical forming compounds to initiate the radical polymerization.

9. The process according to claim 8, wherein polymerizing comprises:
polymerizing in the presence of a free radical-forming initiator (C) and optionally up to 60% by weight-based on the sum of components (A), (B1), (B2), monomers other than (B1) and (B2), and (C)—of at least one solvent (D), in a main polymerization reaction step at a mean polymerization temperature at which the initiator (C) has a decomposition half-life of from 40 to 500 min;
optionally performing at least one further polymerization step to reduce an amount of unreacted monomers;
optionally performing at least one purification step selected from thermal or vacuum distillation or stripping with a gas such as steam or nitrogen, at ambient or reduced pressure, to remove volatile components; and
optionally performing a drying step.

10. The process according to claim 8, wherein:
polymerizing comprises polymerizing in the presence of at least one solvent (D);
the solvent (D) comprises at least one organic solvent and/or water;
the solvent (D) is present in an amounts of up to 60% by weight based on the sum of components (A), (B1), (B2), monomers other than (B1) and (B2), (C), and (D).

11. The process according to claim 8, wherein polymerizing comprises polymerizing such that, during polymerization, a fraction of unconverted monomer (B1), monomer (B2), and monomers other than (B1) and (B2), in the reaction mixture is constantly kept in a quantitative deficiency relative to the polymer backbone (A).

12. The process according to claim 8, wherein the polymerizing comprises polymerizing such that, during polymerization, a fraction of unconverted monomer (B1), monomer (B2), and monomers other than (B1) and (B2), in the reaction mixture is greater than 5 wt % based on a total weight of the graft polymer.

13. The process according to claim 9, wherein an amount of the free radical-forming initiator (C) is from 0.1 to 5% by weight, based on the total weight of the graft polymer.

14. The process according to claim 9, wherein:
polymerizing comprises polymerizing in the presence of the solvent (D); and
the solvent (D) consists of water, except that the radical initiator may be dissolved in small amounts of organic solvent.

15. The process according to claim 9, wherein polymerizing comprises polymerizing without the use of the solvent (D), except any solvent needed for introducing the radical initiator may be present.

16. Graft A graft polymer obtainable obtained by the process according to claim 8.

17-22. (canceled)

23. A cleaning composition in liquid, solid, or semi-solid form, comprising:
the graft polymer according to claim 1 in an amount of about 0.05 wt % to about 20 wt % relative to a total weight of the composition;
about 1% to about 70% by weight of at least one surfactant;
optionally at least one enzyme;
optionally at least one antimicrobial agent; and
optionally 4,4′-dichloro 2-hydroxydiphenylether in a concentration from 0.001 to 3%.

24. (canceled)

25. The composition according to claim 23, wherein the composition is formulated as a laundry detergent.

26. A method of preserving the composition according to claim 23 against microbial contamination or growth, comprising adding 2-phenoxyethanol to the composition, wherein the composition is an aqueous composition comprising water as solvent.

27. A method of laundering fabric or of cleaning hard surfaces, comprising applying the composition of claim 23 to a fabric or a hard surface, wherein the composition comprises 4,4′-dichloro 2-hydroxydiphenylether.
